(19) United States
(12) Patent Application Publication
(10) Pub. No.: US 2026/0116499 A1
(43) Pub. Date: Apr. 30, 2026

(54) HUMAN-POWERED VEHICLE COMPONENT

(71) Applicant: SHIMANO INC., Sakai City (JP)

(72) Inventor: Hiroshi MATSUDA, Sakai City (JP)

(73) Assignee: SHIMANO INC., Sakai City (JP)

(21) Appl. No.: 18/932,645

(22) Filed: Oct. 31, 2024

(51) Int. Cl. B62M 25/08

(52) U.S. Cl. CPC B62M 25/08

(57) ABSTRACT

A human-powered vehicle component comprises wireless communicator circuitry. The wireless communicator circuitry is configured to transmit a first wireless signal to a first additional human-powered vehicle component using a first communication protocol in response to a first user input. The wireless communicator circuitry is configured to transmit a second wireless signal to a second additional human-powered vehicle component using a second communication protocol different from the first communication protocol in response to a second user input different from the first user input.

### BACKGROUND

### Technical Field

The present invention relates to a human-powered vehicle component.

### Background Information

A human-powered vehicle includes components including wireless devices which are configured to communicate with each other. Such wireless devices are paired to establish the wireless communication. However, such wireless devices may use different communication protocols. One of objects of the present disclosure is to improve the usability of the human-powered vehicle component.

### SUMMARY

In accordance with a first aspect of the present invention, a human-powered vehicle component comprises wireless communicator circuitry. The wireless communicator circuitry is configured to transmit a first wireless signal to a first additional human-powered vehicle component using a first communication protocol in response to a first user input. The wireless communicator circuitry is configured to transmit a second wireless signal to a second additional human-powered vehicle component using a second communication protocol different from the first communication protocol in response to a second user input different from the first user input.

With the human-powered vehicle component according to the first aspect, the human-powered vehicle component can be selectively paired with one of the first human-powered vehicle component and the second human-powered vehicle component using corresponding one of the first communication protocol and the second communication protocol. Thus, it is possible to improve the usability of the human-powered vehicle component.

In accordance with a second aspect of the present invention, the human-powered vehicle component according to the first aspect is configured so that the wireless communicator circuitry is configured to be free of transmitting the first wireless signal using the first communication protocol in response to the second user input. The wireless communicator circuitry is configured to be free of transmitting the second wireless signal using the second communication protocol in response to the first user input.

With the human-powered vehicle component according to the second aspect, it is possible to reduce or prevent the user's wrong operation to transmit the first wireless signal or the second wireless signal. Thus, it is possible to reliably improve the usability of the human-powered vehicle component.

In accordance with a third aspect of the present invention, the human-powered vehicle component according to the first or second aspect further comprises first user interface circuitry and second user interface circuitry. The first user interface circuitry is configured to receive the first user input. The second user interface circuitry is configured to receive the second user input.

With the human-powered vehicle component according to the third aspect, the first user interface circuitry and the second user interface circuitry can reduce or prevent the user's wrong operation to transmit the first wireless signal or the second wireless signal. Thus, it is possible to reliably improve the usability of the human-powered vehicle component.

In accordance with a fourth aspect of the present invention, the human-powered vehicle component according to any one of the first to third aspects further comprises memory circuitry configured to store assignment information. The assignment information includes first assignment information indicating that the first user input is assigned to the first communication protocol. The assignment information includes second assignment information indicating that the second user input is assigned to the second communication protocol.

With the human-powered vehicle component according to the fourth aspect, the assignment information can reliably link the first user input and the second user input to the first communication protocol and the second communication protocol, respectively.

In accordance with a fifth aspect of the present invention, the human-powered vehicle component according to any one of the first to fourth aspects is configured so that the first wireless signal includes a first pairing start signal. The second wireless signal includes a second pairing start signal. The wireless communicator circuitry is configured to wirelessly transmit the first pairing start signal to the first additional human-powered vehicle component using the first communication protocol in response to the first user input. The wireless communicator circuitry is configured to wirelessly transmit the second pairing start signal to the second additional human-powered vehicle component using the second communication protocol in response to the second user input.

With the human-powered vehicle component according to the fifth aspect, the first pairing start signal and the second pairing start signal enables the human-powered vehicle component to be reliably paired with the first human-powered vehicle component and the second human-powered vehicle component, respectively. Thus, it is possible to reliably improve the usability of the human-powered vehicle component.

In accordance with a sixth aspect of the present invention, the human-powered vehicle component according to the fifth aspect is configured so that the wireless communicator circuitry is configured to transmit a third wireless signal using the first communication protocol in response to a third user input in a first paired state where the human-powered vehicle component is paired with the first additional human-powered vehicle component using the first communication protocol. The third user input is different from the first user input. The third wireless signal is free of indicating pairing between the human-powered vehicle component and another device.

With the human-powered vehicle component according to the sixth aspect, it is possible to control the first additional human-powered vehicle component using the third wireless signal in the first paired state.

In accordance with a seventh aspect of the present invention, the human-powered vehicle component according to the fifth or sixth aspect is configured so that the wireless communicator circuitry is configured to transmit a fourth wireless signal using the second communication protocol in response to a fourth user input in a second paired state where the human-powered vehicle component is paired with the second additional human-powered vehicle component using the first communication protocol. The fourth user input is different from the second user input. The fourth wireless signal is free of indicating pairing between the human-powered vehicle component and another device.

With the human-powered vehicle component according to the seventh aspect, it is possible to control the second additional human-powered vehicle component using the fourth wireless signal in the second paired state.

In accordance with an eighth aspect of the present invention, the human-powered vehicle component according to any one of the fifth to seventh aspects is configured so that the first pairing start signal indicates that the first additional human-powered vehicle component enters a first pairing mode.

With the human-powered vehicle component according to the eighth aspect, the first paring start signal enables the first additional human-powered vehicle component to enter the first pairing mode without another operation to the first additional human-powered vehicle component. Thus, it is possible to reliably improve the usability of the human-powered vehicle component.

In accordance with a ninth aspect of the present invention, the human-powered vehicle component according to any one of the fifth to eighth aspects is configured so that the second additional human-powered vehicle component is configured to enter a second pairing mode in response to pressing a button of the second additional human-powered vehicle component.

With the human-powered vehicle component according to the ninth aspect, the press of the button enables the second additional human-powered vehicle component to reliably enter the second pairing mode.

In accordance with a tenth aspect of the present invention, the human-powered vehicle component according to any one of the fifth to ninth aspects is configured so that the wireless communicator circuitry is configured to receive a first pairing demand signal transmitted wirelessly from the first additional human-powered vehicle component using the first communication protocol in response to the first pairing start signal. The wireless communicator circuitry is configured to receive a second pairing demand signal transmitted wirelessly from the second additional human-powered vehicle component using the second communication protocol in response to the second pairing start signal.

With the human-powered vehicle component according to the tenth aspect, it is possible to start the pairing process using one of the first pairing start signal and the second pairing start signal. Thus, it is possible to reliably improve the usability of the human-powered vehicle component.

In accordance with an eleventh aspect of the present invention, the human-powered vehicle component according to any one of the first to tenth aspects is configured so that the wireless communicator circuitry is configured to restrict the second wireless signal from being transmitted using the second communication protocol in response to the second user input in a first paired state where the human-powered vehicle component is paired with the first additional human-powered vehicle component using the first communication protocol.

With the human-powered vehicle component according to the eleventh aspect, it is possible to reduce or prevent confusion caused by the pairing with at least two human-powered vehicle components. Furthermore, it is possible to reduce, in the first paired state, the power consumption caused by the transmission of the second wireless signal using the second communication protocol which does not correspond to the first additional human-powered vehicle component.

In accordance with a twelfth aspect of the present invention, the human-powered vehicle component according to any one of the first to eleventh aspects is configured so that the wireless communicator circuitry is configured to restrict the first wireless signal from being transmitted using the first communication protocol in response to the first user input in a first paired state where the human-powered vehicle component is paired with the first additional human-powered vehicle component using the first communication protocol.

With the human-powered vehicle component according to the twelfth aspect, it is possible to reduce or prevent confusion caused by the pairing with at least two human-powered vehicle components.

In accordance with a thirteenth aspect of the present invention, the human-powered vehicle component according to any one of the first to twelfth aspects is configured so that the wireless communicator circuitry is configured to restrict the second wireless signal from being transmitted using the second communication protocol in response to the second user input in a second paired state where the human-powered vehicle component is paired with the second additional human-powered vehicle component using the second communication protocol.

With the human-powered vehicle component according to the thirteenth aspect, it is possible to reduce or prevent confusion caused by the pairing with at least two human-powered vehicle components. Furthermore, it is possible to reduce the power consumption caused by the transmission of the second wireless signal in the second paired state.

In accordance with a fourteenth aspect of the present invention, the human-powered vehicle component according to any one of the first to thirteenth aspects is configured so that the wireless communicator circuitry is configured to restrict the first wireless signal from being transmitted using the first communication protocol in response to the first user input in a second paired state where the human-powered vehicle component is paired with the second additional human-powered vehicle component using the second communication protocol.

With the human-powered vehicle component according to the fourteenth aspect, it is possible to reduce the power consumption caused by the transmission of the first wireless signal in the second paired state.

In accordance with a fifteenth aspect of the present invention, the human-powered vehicle component according to any one of the first to fourteenth aspects is configured so that the wireless communicator circuitry is configured to reset a first paired state where the human-powered vehicle component is paired with the first additional human-powered vehicle component. The wireless communicator circuitry is configured to transmit the first wireless signal using the first communication protocol in response to the first user input after resetting of the first paired state. The wireless communicator circuitry is configured to transmit the second wireless signal using the second communication protocol in response to the second user input after resetting of the first paired state.

With the human-powered vehicle component according to the fifteenth aspect, it is possible to execute the pairing with another human-powered vehicle component other than the first additional human-powered vehicle component after resetting of the first paired state. Thus, it is possible to reliably improve the usability of the human-powered vehicle component.

In accordance with a sixteenth aspect of the present invention, the human-powered vehicle component according to any one of the first to fifteenth aspects is configured so that the wireless communicator circuitry is configured to reset, in response to a reset input, a first paired state where the human-powered vehicle component is paired with the first additional human-powered vehicle component. The wireless communicator circuitry is configured to reset, in response to the reset input, a second paired state where the human-powered vehicle component is paired with the second additional human-powered vehicle component.

With the human-powered vehicle component according to the sixteenth aspect, the reset input enables the user to reset each of the first paired state and the second paired state using the same input, simplifying the reset operation of the paired state.

In accordance with a seventeenth aspect of the present invention, the human-powered vehicle component according to any one of the first to sixteenth aspects further comprises user interface circuitry configured to receive a reset input. The wireless communicator circuitry is configured to reset, in response to the reset input, a first paired state where the human-powered vehicle component is paired with the first additional human-powered vehicle component.

With the human-powered vehicle component according to the seventeenth aspect, the reset input enables the user to reset the first paired state via the user interface circuitry. Thus, it is possible to reliably improve the usability of the human-powered vehicle component.

In accordance with an eighteenth aspect of the present invention, the human-powered vehicle component according to any one of the first to seventeenth aspects is configured so that the wireless communicator circuitry is configured to reset, in response to a reset input indicating an operation of another device, a first paired state where the human-powered vehicle component is paired with the first additional human-powered vehicle component.

With the human-powered vehicle component according to the eighteenth aspect, it is possible to reduce or prevent the user's wrong operation to reset the first paired state.

In accordance with a nineteenth aspect of the present invention, the human-powered vehicle component according to any one of the first to eighteenth aspects is configured so that the first additional human-powered vehicle component includes a first electric actuator. The second additional human-powered vehicle component includes a second electric actuator.

With the human-powered vehicle component according to the nineteenth aspect, it is possible to operate each of the first additional human-powered vehicle component including the first electric actuator and the second additional human-powered vehicle component including the second electric actuator using the human-powered vehicle component.

In accordance with a twentieth aspect of the present invention, the human-powered vehicle component according to the nineteenth aspect is configured so that the first additional human-powered vehicle component is configured to be disposed in a first position. The second additional human-powered vehicle component is configured to be disposed in a second position which is remote from the first position.

With the human-powered vehicle component according to the twentieth aspect, it is possible to each of the first additional human-powered vehicle component and the second additional human-powered vehicle component which are disposed in different positions. Thus, it is possible to reliably improve the usability of the human-powered vehicle component.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a human-powered vehicle including a human-powered vehicle system including at least one human-powered vehicle component in accordance with one of embodiments.

FIG. 2 is a side elevational view of one of the at least one human-powered vehicle component illustrated in FIG. 1.

FIG. 3 is a side elevational view of another of the at least one human-powered vehicle component illustrated in FIG. 1.

FIG. 4 is a side elevational view of another of the at least one human-powered vehicle component illustrated in FIG. 1.

FIG. 5 is a side elevational view of another of the at least one human-powered vehicle component illustrated in FIG. 1.

FIG. 6 is a side elevational view of another of the at least one human-powered vehicle component illustrated in FIG. 1.

FIGS. 7 and 8 are perspective and side elevational views of another of the at least one human-powered vehicle component illustrated in FIG. 1.

FIGS. 9 and 10 are perspective and side elevational views of another of the at least one human-powered vehicle component illustrated in FIG. 1.

FIG. 11 is a schematic block diagram of the human-powered vehicle system illustrated in FIG. 1 (unpaired state).

FIG. 12 is a schematic block diagram of the human-powered vehicle system illustrated in FIG. 1 (first paired state).

FIG. 13 is a schematic block diagram of the human-powered vehicle system illustrated in FIG. 1 (second paired state).

FIGS. 14 to 21 are flowcharts showing wireless communication process between the human-powered vehicle component and each of a first additional human-powered vehicle component and a second additional human-powered vehicle component.

FIG. 22 is a flowchart showing wireless communication process between the human-powered vehicle component and the second additional human-powered vehicle component in accordance with a second modification.

### DESCRIPTION OF THE EMBODIMENTS

The embodiments will now be described with reference to the accompanying drawings, wherein like reference numerals designate corresponding or identical elements throughout the various drawings.

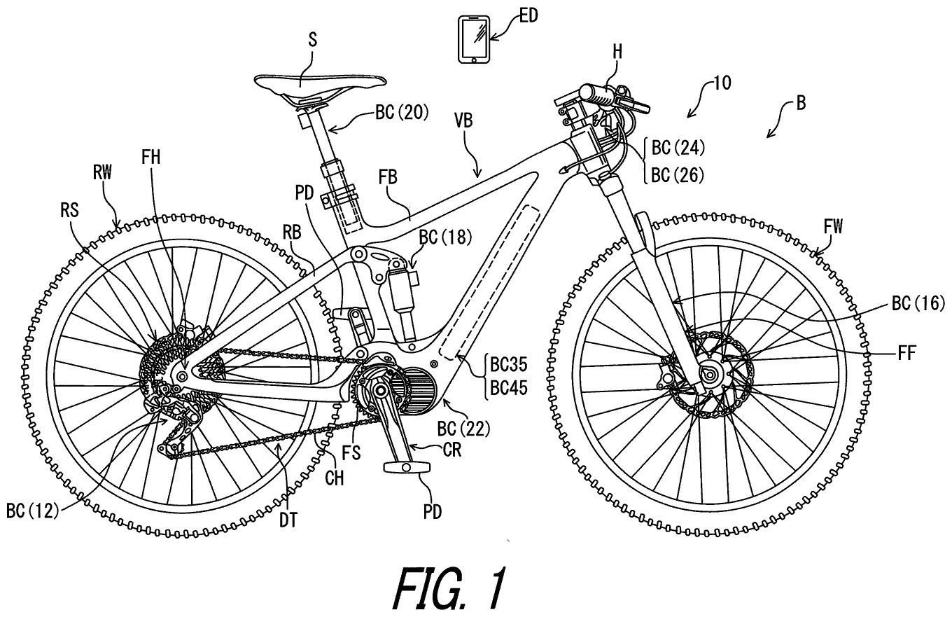

Referring initially to FIG. 1, a human-powered vehicle B includes a human-powered vehicle system 10 including at least one human-powered vehicle component BC in accordance with one of embodiments. In the present embodiment, the human-powered vehicle B is illustrated as an e-bike that uses a driving force of an electric motor in addition to a human driving force for propulsion. However, the human-powered vehicle system 10 can be applied to any other type of human-powered vehicles such as, for example, a mountain bike, a cyclocross bicycle, a gravel bike, a city bike, a cargo bike, and a recumbent bike.

In the present application, the term “human-powered vehicle” includes a vehicle to travel with a motive power including at least a human power of a user who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike called as an E-bike. The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source as motive power. Examples of the driving source include an internal-combustion engine and an electric motor. Generally, a light road vehicle, which includes a vehicle that does not require a driver's license for a public road, is assumed as the human-powered vehicle.

As seen in FIG. 1, the human-powered vehicle B includes a vehicle body VB, a wheel FW, and a wheel RW. The wheel FW is rotatably coupled to the vehicle body VB. The wheel RW is rotatably coupled to the vehicle body VB. The vehicle body VB is supported by the wheels FW and RW. The wheel FW can also be referred to as a front wheel FW. The wheel RW can also be referred to as a rear wheel RW.

The vehicle body VB includes a front frame body FB, a rear frame body RB, a handlebar H, and a front fork FF. The rear frame body RB includes a swing arm. The rear frame body RB is movably coupled to the front frame body FB. The rear frame body RB is pivotally coupled to the front frame body FB. The front fork FF is pivotally coupled to the front frame body FB. The handlebar H is coupled to the front fork FF to be pivotable relative to the front frame body FB along with the front fork FF.

The human-powered vehicle B further includes a drivetrain DT. Here, for example, the drivetrain DT is a chain-drive type and includes a crank CR, at least one front sprocket FS, at least two rear sprockets RS, a chain CH, and pedals PD. The crank CR is rotatably coupled to the vehicle body VB. The at least one front sprocket FS is coupled to the crank CR to rotate relative to the vehicle body VB along with the crank CR. The rear sprockets RS are provided on a hub assembly FH of the wheel RW. The chain CH is configured to be engaged with one of the at least one front sprocket FS and one of the at least two rear sprockets RS. The pedals PD are coupled to the crank CR. A human driving force is applied to the pedals PD by a rider such that the driving force is transmitted to the wheel RW via the at least one front sprocket FS, the chain CH, and the at least two rear sprockets RS. While the drivetrain DT is illustrated as a chain-drive type of drivetrain, the drivetrain DT can be selected from any type of drivetrain and can be a belt-drive type or a shaft-drive type.

In the present application, the following directional terms “front,” “rear,” “forward,” “rearward,” “left,” “right,” “transverse,” “upward” and “downward” as well as any other similar directional terms refer to those directions which are determined based on the user who is in the user's standard position in the human-powered vehicle B while the user faces toward a handlebar or steering. Examples of the user's standard position include a saddle and a seat. Accordingly, these terms, as utilized to describe the human-powered vehicle system 10, the human-powered vehicle component BC, or other components, should be interpreted relative to the human-powered vehicle B equipped with the human-powered vehicle system 10, the human-powered vehicle component BC, or other components as used in an upright riding position on a horizontal surface.

As seen in FIG. 1, the at least one human-powered vehicle component BC includes a gear changer 12, a suspension 16, a suspension 18, an adjustable seatpost 20, and an assist drive unit 22. Namely, the human-powered vehicle B includes the gear changer 12, the suspension 16, the suspension 18, the adjustable seatpost 20, and the assist drive unit 22. The gear changer 12 is configured to be mounted to the vehicle body VB. The suspension 16 is configured to be mounted to the vehicle body VB. The suspension 18 is configured to be mounted to the vehicle body VB. The adjustable seatpost 20 is configured to be mounted to the vehicle body VB. The assist drive unit 22 is configured to be mounted to the vehicle body VB.

As seen in FIG. 1, the gear changer 12 is configured to change a gear ratio of the human-powered vehicle B. The gear ratio is a ratio of a rotational speed of the at least two rear sprockets RS to a rotational speed of the at least one front sprocket FS. The gear changer 12 is configured to shift the chain CH relative to the at least two rear sprockets RS. In the present embodiment, the gear changer 12 includes a rear derailleur. However, the gear changer 12 can include another type of gear changer 12 if needed or desired. Examples of another type of gear changer 12 include a front derailleur and an internal-gear hub.

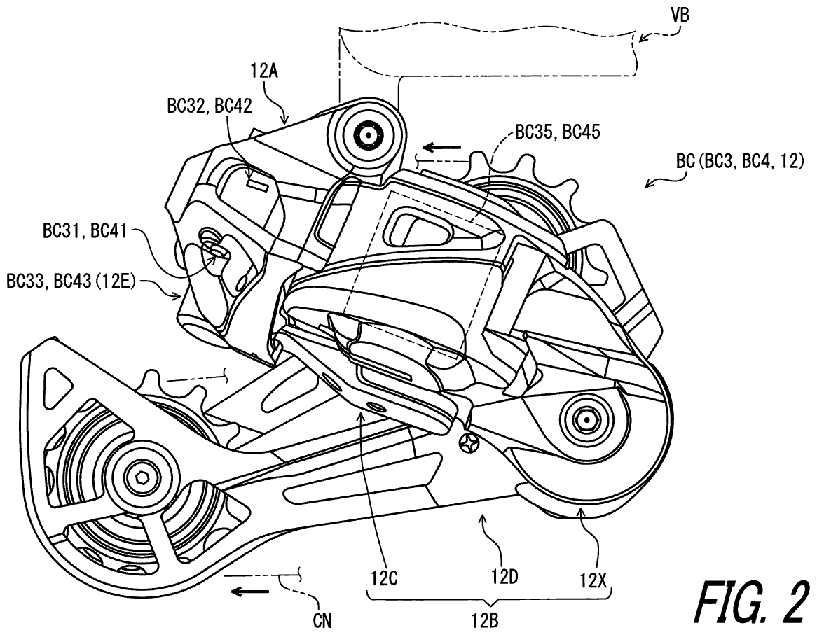

As seen in FIG. 2, the gear changer 12 includes a base member 12A and a movable structure 12B. The base member 12A is mountable to the vehicle body VB. The movable structure 12B is movable relative to the base member 12A. For example, the movable structure 12B includes a linkage 12C, a chain guide 12D, and a movable member 12X. The chain guide 12D is contactable with the chain CH. The chain guide 12D is pivotally coupled to the movable member 12X. The linkage 12C movably couples the base member 12A and the movable member 12X.

The gear changer 12 comprises an electric actuator 12E. The electric actuator 12E is configured to generate actuation force. Examples of the electric actuator 12E include an electric motor. The electric actuator 12E is coupled to at least one of the base member 12A and the movable structure 12B to move the movable structure 12B relative to the base member 12A. The electric actuator 12E is at least partially provided to at least one of the base member 12A, the linkage 12C, the chain guide 12D, and the movable member 12X. The electric actuator 12E can be configured to be controlled based on a control signal transmitted from another device or to be automatically controlled based on information relating to the human-powered vehicle B.

As seen in FIG. 1, the suspension 16 is configured to absorb or damp shocks or vibrations generated by riding on rough terrain. The suspension 16 is installed in the front fork FF. The suspension 16 and the front fork FF constitute a suspension fork. The suspension 16 is configured to absorb or damp shocks or vibrations transmitted from at least one of the wheels FW and RW.

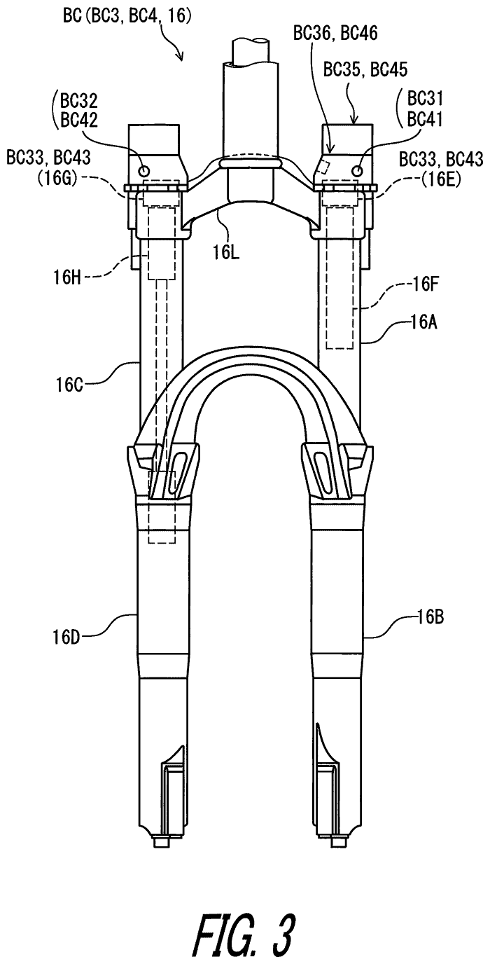

As seen in FIG. 3, the suspension 16 includes a first longitudinal member 16A and a second longitudinal member 16B. The first longitudinal member 16A and the second longitudinal member 16B are relatively movable. The suspension 16 includes a crown 16L. The first longitudinal member 16A is coupled to the crown 16L. The wheel FW is rotatably coupled to the second longitudinal member 16B. For example, the first longitudinal member 16A and the second longitudinal member 16B define a fluid chamber filled with a fluid such as oil.

The suspension 16 includes a third longitudinal member 16C and a fourth longitudinal member 16D. The third longitudinal member 16C and the fourth longitudinal member 16D are relatively movable. The third longitudinal member 16C is coupled to the crown 16L. The wheel FW is rotatably coupled to the fourth longitudinal member 16D. For example, the third longitudinal member 16C and the fourth longitudinal member 16D define an air chamber filled with air.

The suspension 16 comprises an electric actuator 16E. The electric actuator 16E is configured to generate actuation force. For example, the electric actuator 16E includes an electric motor and a motor driver. The motor driver is electrically connected to the electric motor to control the electric motor.

The suspension 16 includes a state changing structure 16F configured to change the state of the suspension 16 between a first state and a second state. The electric actuator 16E is configured to actuate the state changing structure 16F to change the state of the suspension 16 between the first state and the second state. For example, the state changing structure 16F includes a valve unit. The electric actuator 16E is coupled to the state changing structure 16F. The electric actuator 16E is configured to actuate the state changing structure 16F to change the state of the suspension 16 between the first state and the second state.

For example, the state changing structure 16F is configured to allow the first longitudinal member 16A and the second longitudinal member 16B to relatively move under a first damping property in the first state. The state changing structure 16F is configured to allow the first longitudinal member 16A and the second longitudinal member 16B to relatively move under a second damping property in the second state. The second damping property is different from the first damping property.

The suspension 16 comprises an electric actuator 16G. The electric actuator 16G is configured to generate actuation force. For example, the electric actuator 16G includes an electric motor and a motor driver. The motor driver is electrically connected to the electric motor to control the electric motor.

The suspension 16 includes a state changing structure 16H configured to change the state of the suspension 16 between a third state and a fourth state. The electric actuator 16E is configured to actuate the state changing structure 16H to change the state of the suspension 16 between the third state and the fourth state. For example, the state changing structure 16H includes a valve unit. The electric actuator 16G is coupled to the state changing structure 16H. The electric actuator 16G is configured to actuate the state changing structure 16H to change the state of the suspension 16 between the first state and the second state.

For example, the state changing structure 16H is configured to allow the third longitudinal member 16C and the fourth longitudinal member 16D to relatively move within a first stroke in the third state. The state changing structure 16H is configured to allow the third longitudinal member 16C and the fourth longitudinal member 16D to relatively move within a second stroke in the fourth state. The second stroke is different from the first stroke. One of the first stroke and the second stroke can be zero.

In the present embodiment, the suspension 16 includes the electric actuator 16E, the state changing structure 16F, the electric actuator 16G, and the state changing structure 16H. However, the electric actuator 16E and the state changing structure 16F can be omitted from the suspension 16 if needed or desired. The electric actuator 16G and the state changing structure 16H can be omitted from the suspension 16 if needed or desired. Furthermore, the suspension 16 can include another type of a state changing structure other than the state changing structures 16F and 16H if needed or desired.

As seen in FIG. 1, the suspension 18 is configured to absorb or damp shocks or vibrations generated by riding on rough terrain. The suspension 18 is coupled to the front frame body FB and the rear frame body RB. The suspension 18 is configured to absorb or damp shocks or vibrations transmitted from at least one of the wheels FW and RW.

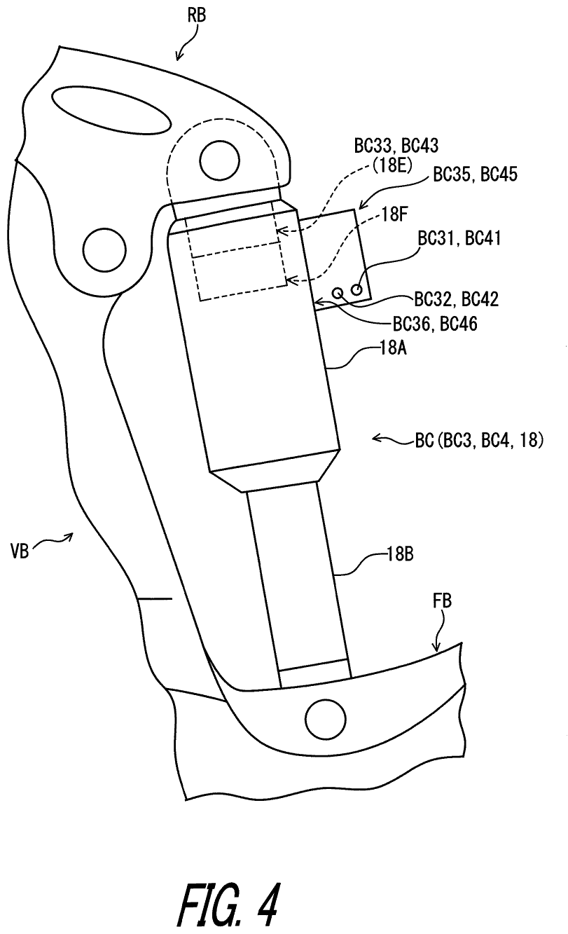

As seen in FIG. 4, the suspension 18 includes a first longitudinal member 18A and a second longitudinal member 18B. The first longitudinal member 18A and the second longitudinal member 18B are relatively movable. The first longitudinal member 18A and the second longitudinal member 18B define an air chamber or a fluid chamber. The first longitudinal member 18A is pivotally coupled to the rear frame body RB. The second longitudinal member 18B is pivotally coupled to the front frame body FB.

The suspension 18 comprises an electric actuator 18E. The electric actuator 18E is configured to generate actuation force. For example, the electric actuator 18E includes an electric motor and a motor driver. The motor driver is electrically connected to the electric motor to control the electric motor.

The suspension 18 includes a state changing structure 18F configured to change the state of the suspension 18 between a first state and a second state. The electric actuator 18E is configured to actuate the state changing structure 18F to change the state of the suspension 18 between the first state and the second state. For example, the state changing structure 18F includes a valve unit. The electric actuator 18E is coupled to the state changing structure 18F. The electric actuator 18E is configured to actuate the state changing structure 18F to change the state of the suspension 18 between the first state and the second state.

The state changing structure 18F is configured to allow the first longitudinal member 18A and the second longitudinal member 18B to relatively move within a first stroke or under a first damping property in the first state. The state changing structure 18F is configured to allow the first longitudinal member 18A and the second longitudinal member 18B to relatively move within a second stroke or under a second damping property in the second state.

As seen in FIG. 1, the adjustable seatpost 20 is configured to change a height of the saddle S relative to the vehicle body VB. The adjustable seatpost 20 has an adjustable state and a locked state. The adjustable seatpost 20 allows the user to change the height of the saddle S in the adjustable state. The adjustable seatpost 20 is locked to maintain the height of the saddle S in the locked state. The adjustable seatpost 20 is configured to change the state of the adjustable seatpost 20 between the adjustable state and the locked state.

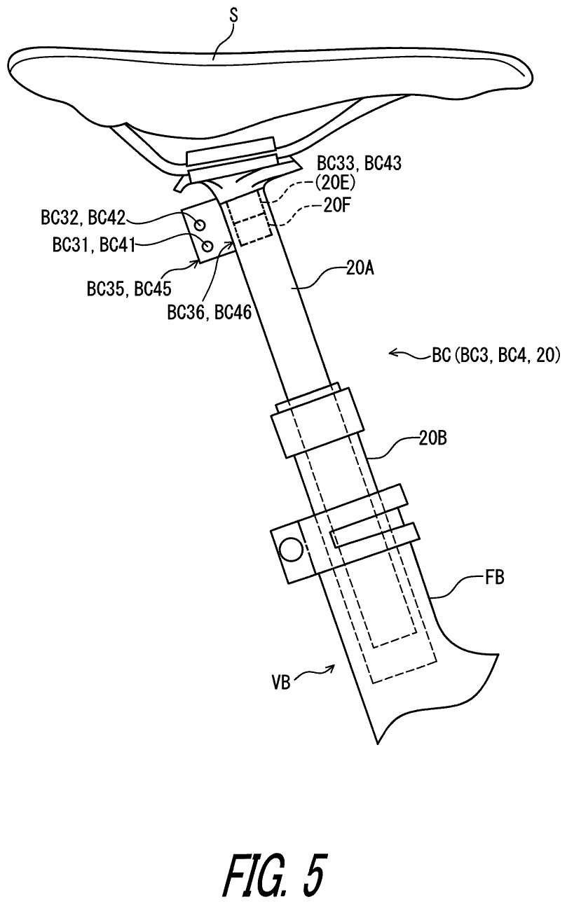

As seen in FIG. 5, the adjustable seatpost 20 includes a first longitudinal member 20A and a second longitudinal member 20B. The first longitudinal member 20A and the second longitudinal member 20B are relatively movable. The saddle S is coupled to the first longitudinal member 20A. The second longitudinal member 20B is coupled to the vehicle body VB.

The adjustable seatpost 20 comprises an electric actuator 20E. The electric actuator 20E is configured to generate actuation force. For example, the electric actuator 20E includes an electric motor and a motor driver. The motor driver is electrically connected to the electric motor to control the electric motor.

The adjustable seatpost 20 includes a state changing structure 20F configured to change the state of the adjustable seatpost 20 between the adjustable state and the locked state. The electric actuator 20E is configured to actuate the state changing structure 20F to change the state of the adjustable seatpost 20 between the adjustable state and the locked state. For example, the state changing structure 20F includes a valve unit. The electric actuator 20E is coupled to the state changing structure 20F. The electric actuator 20E is configured to actuate the state changing structure 20F to change the state of the adjustable seatpost 20 between the adjustable state and the locked state.

The state changing structure 20F is configured to allow the first longitudinal member 20A and the second longitudinal member 20B to relatively move in the adjustable state. The state changing structure 20F is configured to restrict the first longitudinal member 20A and the second longitudinal member 20B from relatively moving in the locked state.

As seen in FIG. 1, the assist drive unit 22 is configured to assist propulsion of the human-powered vehicle B. The assist drive unit 22 is configured to change an assist ratio depending on a human power applied to the human-powered vehicle B. For example, the assist drive unit 22 is configured to change the assist ratio depending on pedaling torque applied to the crank CR.

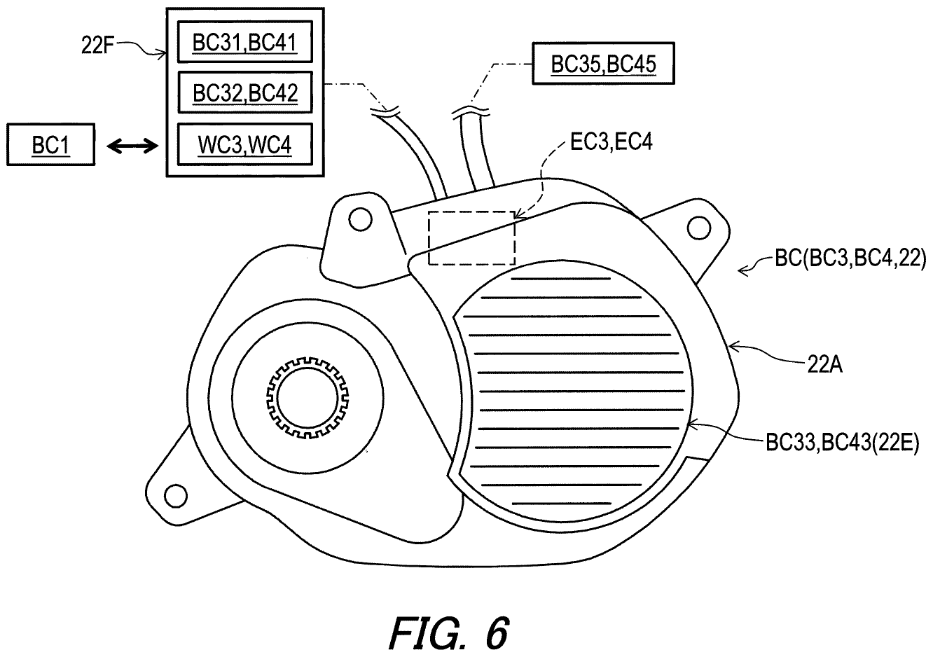

As seen in FIG. 6, the assist drive unit 22 comprises a housing 22A and an electric actuator 22E. The electric actuator 22E is configured to apply the actuation force to the human-powered vehicle B to assist propulsion of the human-powered vehicle B. The electric actuator 22E is at least partially provided in the housing 22A. The electric actuator 22E is configured to generate actuation force. For example, the electric actuator 22E includes an electric motor and a motor driver. The motor driver is electrically connected to the electric motor to control the electric motor.

The assist drive unit 22 includes an assist operating device 22F. The assist operating device 22F is electrically connected, via an electrical cable, to controller circuitry configured to control the electric actuator 22E. The assist operating device 22F is configured to receive a user input. The controller circuitry of the assist drive unit 22 is configured to control the electric actuator 22E based on the user input received by the assist operating device 22F.

As seen in FIG. 1, the at least one human-powered vehicle component BC includes an operating device 24. The operating device 24 is configured to be mounted to the handlebar H. The operating device 24 is configured to receive a user input. The operating device 24 is configured to operate at least one of the at least one human-powered vehicle component BC in response to the user input. The operating device 24 is configured to operate at least one of the gear changer 12, the suspension 16, the suspension 18, the adjustable seatpost 20, and the assist drive unit 22 in response to the user input.

The at least one human-powered vehicle component BC includes an operating device 26. The operating device 26 is configured to be mounted to the handlebar H. The operating device 26 is configured to receive a user input. The operating device 26 is configured to operate at least one of the at least one human-powered vehicle component BC in response to the user input. The operating device 26 is configured to operate at least one of the gear changer 12, the suspension 16, the suspension 18, the adjustable seatpost 20, and the assist drive unit 22 in response to the user input.

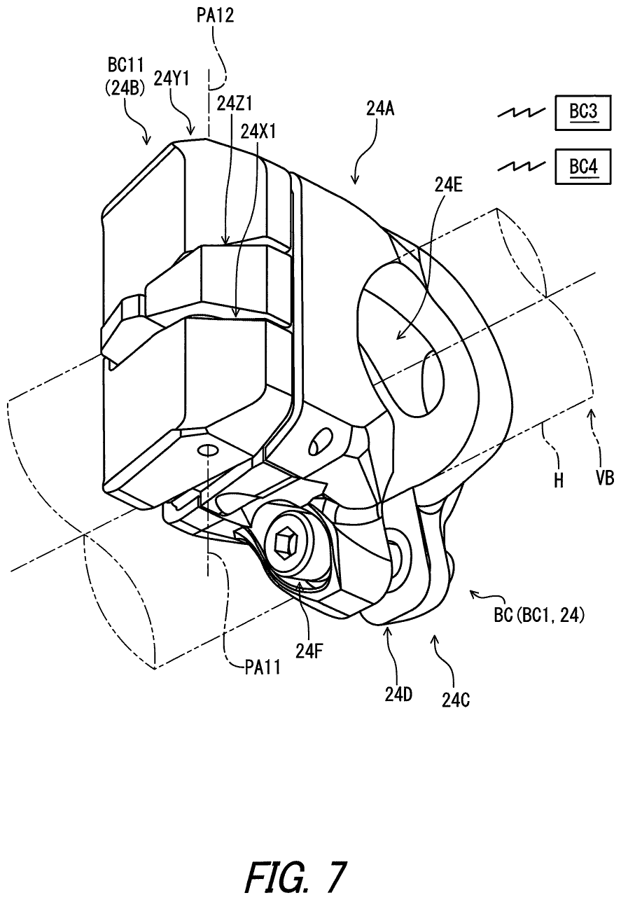

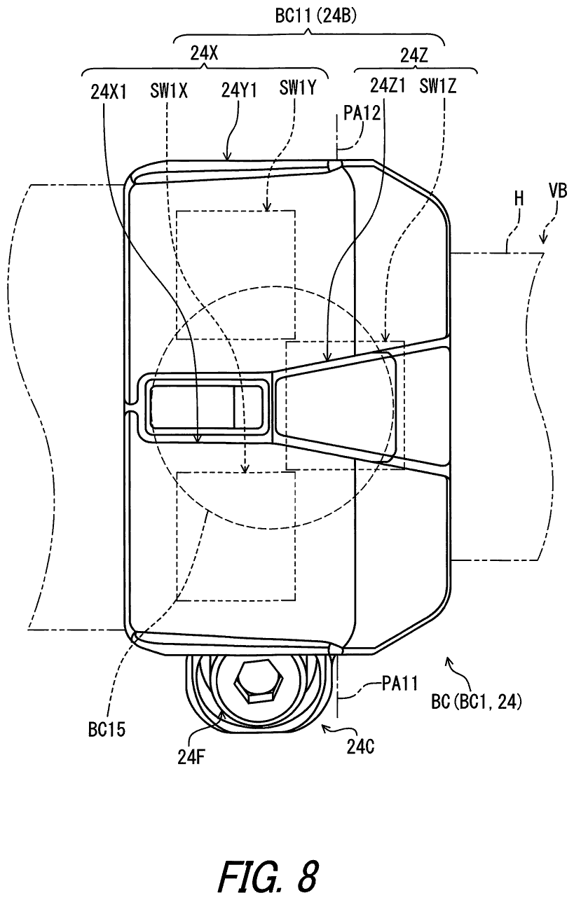

As seen in FIGS. 7 and 8, the operating device 24 is a right-hand operating device configured to be operated by the user's right hand. The operating device 24 includes a housing 24A, user interface circuitry 24B, and a mounting portion 24C. The housing 24A is configured to be mounted to the vehicle body VB of the human-powered vehicle B. The user interface circuitry 24B is configured to be operated by the user to control at least one of the at least one human-powered vehicle component BC while the human-powered vehicle B is running. The mounting portion 24C is configured to couple the housing 24A and the vehicle body VB. The mounting portion 24C is configured to couple the housing 24A and the handlebar H of the vehicle body VB. For example, the mounting portion 24C includes a clamp 24D and a clamp fastener 24F. The clamp 24D includes a clamp opening 24E through which the handlebar H is to extend. The clamp fastener 24F is configured to fasten the clamp 24D to the handlebar H.

As seen in FIG. 8, the user interface circuitry 24B includes first user interface circuitry 24X. The first user interface circuitry 24X includes a first operating member 24X1 and a first switch SW1X. The first operating member 24X1 is movably coupled to the housing 24A. For example, the first operating member 24X1 is pivotally coupled to the housing 24A about a first pivot axis PA11. The first switch SW1X is at least partially provided between the first operating member 24X1 and the housing 24A. The first switch SW1X is configured to receive a user input via the first operating member 24X1.

The first user interface circuitry 24X includes a first operating member 24Y1 and a first switch SW1Y. The first operating member 24Y1 is movably coupled to the housing 24A. For example, the first operating member 24Y1 is pivotally coupled to the housing 24A about a first pivot axis PA12. The first switch SW1Y is at least partially provided between the first operating member 24Y1 and the housing 24A. The first switch SW1Y is configured to receive a user input via the first operating member 24Y1.

The user interface circuitry 24B includes second user interface circuitry 24Z. The second user interface circuitry 24Z includes a second operating member 24Z1 and a second switch SW1Z. The second operating member 24Z1 is movably coupled to the housing 24A. The second switch SW1Z is at least partially provided between the second operating member 24Z1 and the housing 24A. The second switch SW1Z is configured to receive a user input via the second operating member 24Z1.

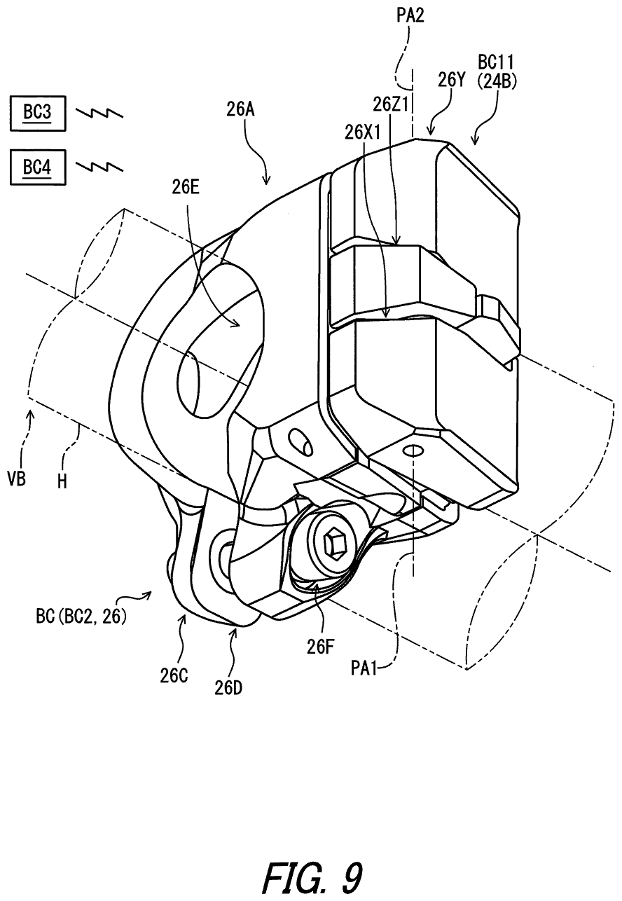

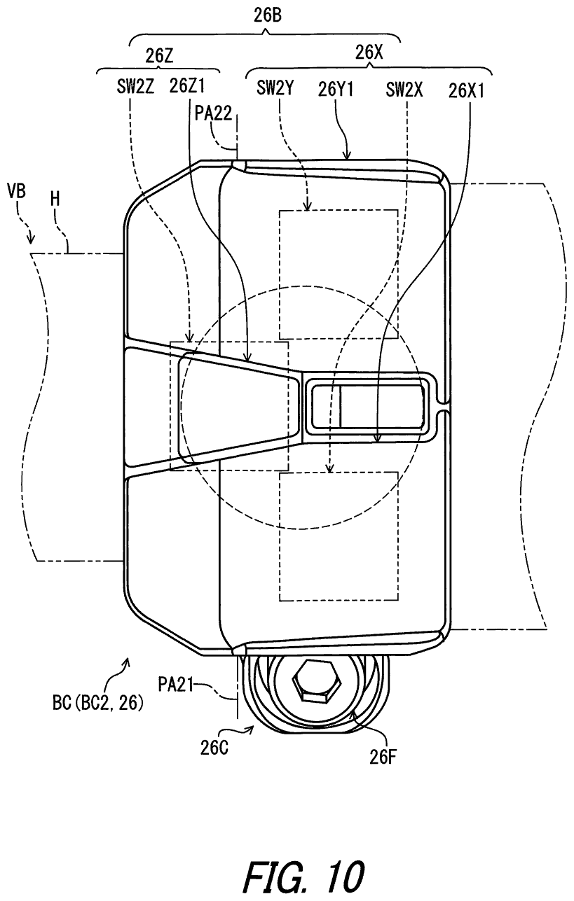

As seen in FIGS. 9 and 10, the operating device 26 is a left-hand operating device configured to be operated by the user's left hand. The operating device 26 includes a housing 26A, user interface circuitry 26B, and a mounting portion 26C. The housing 26A is configured to be mounted to the vehicle body VB of the human-powered vehicle B. The user interface circuitry 26B is configured to be operated by the user to control at least one of the at least one human-powered vehicle component BC while the human-powered vehicle B is running. The mounting portion 26C is configured to couple the housing 26A and the vehicle body VB. The mounting portion 26C is configured to couple the housing 26A and the handlebar H of the vehicle body VB. For example, the mounting portion 26C includes a clamp 26D and a clamp fastener 26F. The clamp 26D includes a clamp opening 26E through which the handlebar H is to extend. The clamp fastener 26F is configured to fasten the clamp 26D to the handlebar H.

As seen in FIG. 10, the user interface circuitry 26B includes first user interface circuitry 26X. The first user interface circuitry 26X includes a first operating member 26X1 and a first switch SW2X. The first operating member 26X1 is movably coupled to the housing 26A. For example, the first operating member 26X1 is pivotally coupled to the housing 26A about a first pivot axis PA21. The first switch SW2X is at least partially provided between the first operating member 26X1 and the housing 26A. The first switch SW2X is configured to receive a user input via the first operating member 26X1.

The user interface circuitry 26B includes first user interface circuitry 26Y. The first user interface circuitry 26Y includes a first operating member 26Y1 and a first switch SW2Y. The first operating member 26Y1 is movably coupled to the housing 26A. For example, the first operating member 26Y1 is pivotally coupled to the housing 26A about a first pivot axis PA22. The first switch SW2Y is at least partially provided between the first operating member 26Y1 and the housing 26A. The first switch SW2Y is configured to receive a user input via the first operating member 26Y1.

The user interface circuitry 26B includes second user interface circuitry 26Z. The second user interface circuitry 26Z includes a second operating member 26Z1 and a second switch SW2Z. The second operating member 26Z1 is movably coupled to the housing 26A. The second switch SW2Z is at least partially provided between the second operating member 26Z1 and the housing 26A. The second switch SW2Z is configured to receive a user input via the second operating member 26Z1.

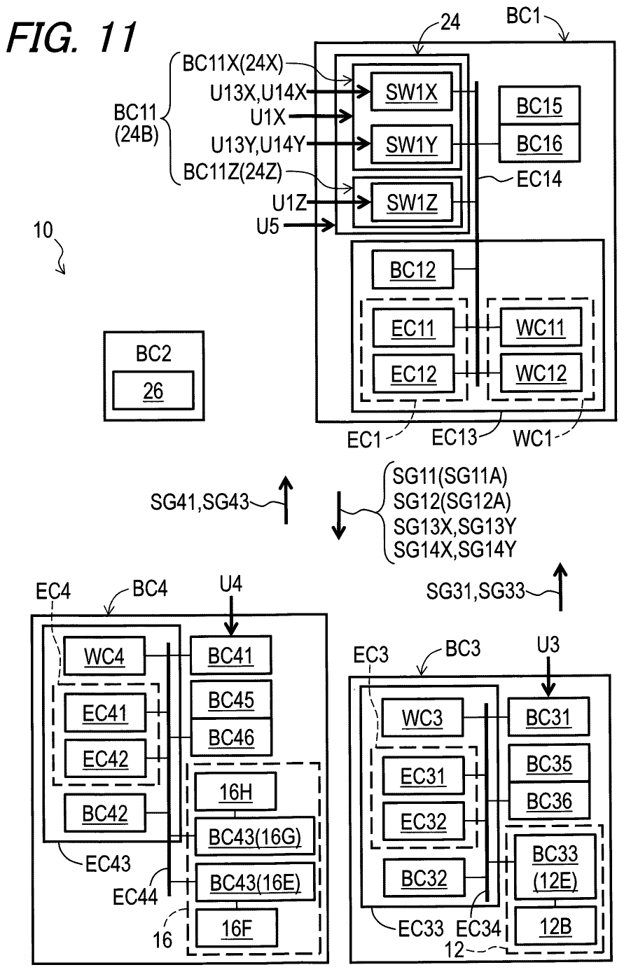

As seen in FIG. 11, the user interface circuitry 24B is configured to receive a first user input U1X, a second user input U1Z, a third user input U13X, a third user input U13Y, a fourth user input U14X, a fourth user input U14Y, or a reset input U5. The first user interface circuitry 24X is configured to receive the first user input U1X, the third user input U13X, the fourth user input U14X, the third user input U13Y, or the fourth user input U14Y. The second user interface circuitry 24Z is configured to receive the second user input U1Z.

For example, the first user input U1X includes one of a normal press of the first switch SW1X, a long press of the first switch SW1X, a double click of the first switch SW1X, a normal press of the first switch SW1Y, a long press of the first switch SW1Y, a double click of the first switch SW1Y, a simultaneous normal press of the first switches SW1X and SW1Y, a simultaneous long press of the first switches SW1X and SW1Y, a simultaneous double click of the first switches SW1X and SW1Y.

The third user input U13X includes another of the normal press of the first switch SW1X, the long press of the first switch SW1X, and the double click of the first switch SW1X. The fourth user input U14X includes another of the normal press of the first switch SW1X, the long press of the first switch SW1X, and the double click of the first switch SW1X.

The third user input U13Y includes another of the normal press of the first switch SW1Y, the long press of the first switch SW1Y, and the double click of the first switch SW1Y. The fourth user input U14Y includes another of the normal press of the first switch SW1Y, the long press of the first switch SW1Y, and the double click of the first switch SW1Y.

The second user input U1Z includes one of a normal press of the second switch SW1Z, a long press of the second switch SW1Z, and a double click of the second switch SW1Z.

The reset input U5 includes one of the combination of at least two of the normal press of the first switch SW1X, the normal press of the first switch SW1Y, and the normal press of the second switch SW1Z and the combination of at least two of the long press of the first switch SW1X, the long press of the first switch SW1Y, and the long press of the second switch SW1Z. The reset input U5 can include other types of inputs. For example, the reset input U5 can include an input transmitted from a device other than the human-powered vehicle component BC1.

As seen in FIG. 11, the at least one human-powered vehicle component BC includes a human-powered vehicle component BC1, a human-powered vehicle component BC2, a first additional human-powered vehicle component BC3, and a second additional human-powered vehicle component BC4. Namely, the human-powered vehicle system 10 comprises the human-powered vehicle component BC1, the human-powered vehicle component BC2, the first additional human-powered vehicle component BC3, and the second additional human-powered vehicle component BC4. The human-powered vehicle component BC1, the first additional human-powered vehicle component BC3, and the second additional human-powered vehicle component BC4 are different from each other. The first additional human-powered vehicle component BC3 is configured to be disposed in a first position. The second additional human-powered vehicle component BC4 is configured to be disposed in a second position which is remote from the first position.

The human-powered vehicle component BC1 includes one of the gear changer 12, the suspension 16, the suspension 18, the assist drive unit 22, the adjustable seatpost 20, the operating device 24, and the operating device 26. The human-powered vehicle component BC2 includes one of the gear changer 12, the suspension 16, the suspension 18, the assist drive unit 22, the adjustable seatpost 20, the operating device 24, and the operating device 26. The first additional human-powered vehicle component BC3 includes another of the gear changer 12, the suspension 16, the suspension 18, the assist drive unit 22, the adjustable seatpost 20, the operating device 24, and the operating device 26. The second additional human-powered vehicle component BC4 includes another of the gear changer 12, the suspension 16, the suspension 18, the assist drive unit 22, the adjustable seatpost 20, the operating device 24, and the operating device 26.

In the present embodiment, the human-powered vehicle component BC1 includes the operating device 24. The human-powered vehicle component BC2 includes the operating device 26. The first additional human-powered vehicle component BC3 includes the gear changer 12. The second additional human-powered vehicle component BC4 includes the suspension 16. However, the human-powered vehicle component BC1 is not limited to the operating device 24. The human-powered vehicle component BC2 is not limited to the operating device 26. The first additional human-powered vehicle component BC3 is not limited to the gear changer 12. The second additional human-powered vehicle component BC4 is not limited to the suspension 16. The human-powered vehicle component BC1 can include a device other than the operating device 24 if needed or desired. The human-powered vehicle component BC2 can include a device other than the operating device 26 if needed or desired. The first additional human-powered vehicle component BC3 can include a device other than the gear changer 12 if needed or desired. The second additional human-powered vehicle component BC4 can include a device other than the suspension 16 if needed or desired. For example, the human-powered vehicle component BC1 can include the operating device 26 while the human-powered vehicle component BC2 can include the operating device 24.

The human-powered vehicle component BC1 further comprises user interface circuitry BC11. In a case where the human-powered vehicle component BC1 includes the operating device 24, the human-powered vehicle component BC1 comprises the first user interface circuitry 24X and the second user interface circuitry 24Z. The first user interface circuitry 24X can be referred to as first user interface circuitry BC11X. The second user interface circuitry 24Z can be referred to as second user interface circuitry BC11Z. Namely, the human-powered vehicle component BC1 comprises the first user interface circuitry BC11X and/or BC11Y and the second user interface circuitry BC11Z. The user interface circuitry BC11 is configured to receive the first user input U1X, the second user input U1Z, the third user input U13X or U13Y, or the fourth user input U14X or U14Y. The user interface circuitry BC11 is configured to receive the reset input U5.

The first user interface circuitry BC11X is configured to receive the first user input U1X. The second user interface circuitry BC11Z is configured to receive the second user input U1Z. The first user interface circuitry BC11X is configured to receive the third user input U13X. The first user interface circuitry BC11X is configured to receive the fourth user input U14X. The first user interface circuitry BC11X is configured to receive the third user input U13Y. The first user interface circuitry BC11X is configured to receive the fourth user input U14Y.

At least two of the first user interface circuitry BC11X and the second user interface circuitry BC11Z are configured to receive the reset input U5.

As seen in FIGS. 2 to 6, the electric actuators 12E, 16E, 16G, 18E, 20E, and 22E can also be referred to as first electric actuators12E, 16E, 16G, 18E, 20E, and 22E. Each of the first electric actuators 12E, 16E, 16G, 18E, 20E, and 22E can also be referred to as the first electric actuator BC33. The first electric actuator BC33 is configured to generate actuation force.

As seen in FIG. 2, in a case where the first additional human-powered vehicle component BC3 includes the gear changer 12, the first additional human-powered vehicle component BC3 includes the first electric actuator BC33 or 12E. As seen in FIG. 3, in a case where the first additional human-powered vehicle component BC3 includes the suspension 16, the first additional human-powered vehicle component BC3 includes the first electric actuator BC33, 16E, and/or 16G. As seen in FIG. 4, in a case where the first additional human-powered vehicle component BC3 includes the suspension 18, the first additional human-powered vehicle component BC3 includes the first electric actuator BC33 or 18E. As seen in FIG. 5, in a case where the first additional human-powered vehicle component BC3 includes the adjustable seatpost 20, the first additional human-powered vehicle component BC3 includes the first electric actuator BC33 or 20E. As seen in FIG. 6, in a case where the first additional human-powered vehicle component BC3 includes the assist drive unit 22, the first additional human-powered vehicle component BC3 includes the first electric actuator BC33 or 22E.

As seen in FIGS. 2 to 6, the electric actuators 12E, 16E, 16G, 18E, 20E, and 22E can also be referred to as second electric actuators12E, 16E, 16G, 18E, 20E, and 22E. Each of the second electric actuators 12E, 16E, 16G, 18E, 20E, and 22E can also be referred to as the second electric actuator BC43. The second electric actuator BC43 is configured to generate actuation force.

As seen in FIG. 2, in a case where the second additional human-powered vehicle component BC4 includes the gear changer 12, the second additional human-powered vehicle component BC4 includes the second electric actuator BC43 or 12E. As seen in FIG. 3, in a case where the second additional human-powered vehicle component BC4 includes the suspension 16, the second additional human-powered vehicle component BC4 includes the second electric actuator BC43, 16E, and/or 16G. As seen in FIG. 4, in a case where the second additional human-powered vehicle component BC4 includes the suspension 18, the second additional human-powered vehicle component BC4 includes the second electric actuator BC43 or 18E. As seen in FIG. 5, in a case where the second additional human-powered vehicle component BC4 includes the adjustable seatpost 20, the second additional human-powered vehicle component BC4 includes the second electric actuator BC43 or 20E. As seen in FIG. 6, in a case where the second additional human-powered vehicle component BC4 includes the assist drive unit 22, the second additional human-powered vehicle component BC4 includes the second electric actuator BC43 or 22E.

In the present embodiment, at least one of the human-powered vehicle component BC1, the human-powered vehicle component BC2, the first additional human-powered vehicle component BC3, and the second additional human-powered vehicle component BC4 has only a function relating to the human-powered vehicle B. Each of the human-powered vehicle component BC1 and the human-powered vehicle component BC2 has only the function relating to the human-powered vehicle B. However, at least one of the human-powered vehicle component BC1, the human-powered vehicle component BC2, the first additional human-powered vehicle component BC3, and the second additional human-powered vehicle component BC4 can have a function other than the function relating to the human-powered vehicle B if needed or desired.

As seen in FIG. 11, the human-powered vehicle component BC1 is configured to establish a wireless connection between the human-powered vehicle component BC1 and another human-powered vehicle component such as the first additional human-powered vehicle component BC3 or the second additional human-powered vehicle component BC4. The human-powered vehicle component BC2 is configured to establish a wireless connection between the human-powered vehicle component BC2 and another human-powered vehicle component such as the first additional human-powered vehicle component BC3 or the second additional human-powered vehicle component BC4. The human-powered vehicle component BC1 is configured to wirelessly transmit or receive a signal to or from another human-powered vehicle component such as the first additional human-powered vehicle component BC3 or the second additional human-powered vehicle component BC4 in a wireless connection state where the wireless connection is established. The human-powered vehicle component BC2 is configured to wirelessly transmit or receive a signal to or from another human-powered vehicle component such as the first additional human-powered vehicle component BC3 or the second additional human-powered vehicle component BC4 in the wireless connection state where the wireless connection is established.

The human-powered vehicle component BC2 has substantially the same structure as the structure of the human-powered vehicle component BC1. Thus, it will not be described in detail here for the sake of brevity. The description of the human-powered vehicle component BC1 can be utilized to describe the human-powered vehicle component BC2.

As seen in FIG. 11, the human-powered vehicle component BC1 comprises wireless communicator circuitry WC1. The human-powered vehicle component BC1 further comprises controller circuitry EC1. The controller circuitry EC1 is electrically connected to the wireless communicator circuitry WC1.

The wireless communicator circuitry WC1 is configured to wirelessly communicate with another wireless communicator circuitry. The controller circuitry EC1 is electrically connected to the wireless communicator circuitry WC1 to control the wireless communicator circuitry WC1.

In the present embodiment, the wireless communicator circuitry WC1 includes first wireless communicator circuitry WC11 and second wireless communicator circuitry WC12. As discussed later, the first wireless communicator circuitry WC11 and the second wireless communicator circuitry WC12 use different communication protocols. The second wireless communicator circuitry WC12 is separately provided from the first wireless communicator circuitry WC11. Alternatively, the second wireless communicator circuitry WC12 can be at least partially integrated with the first wireless communicator circuitry WC11 as a one chip.

The first wireless communicator circuitry WC11 is configured to wirelessly communicate with another wireless communicator circuitry using a first communication protocol. The controller circuitry EC1 is electrically connected to the first wireless communicator circuitry WC11 to control the first wireless communicator circuitry WC11.

The second wireless communicator circuitry WC12 is configured to wirelessly communicate with another wireless communicator circuitry using a second communication protocol different from the first communication protocol. The controller circuitry EC1 is electrically connected to the second wireless communicator circuitry WC12 to control the second wireless communicator circuitry WC12.

The controller circuitry EC1 includes at least one processor EC11 and memory circuitry EC12. Namely, the human-powered vehicle component BC1 further comprises memory circuitry EC12. The human-powered vehicle component BC1 includes at least one circuit board EC13 and at least one system bus EC14. The controller circuitry EC1 is electrically mounted on the at least one circuit board EC13. The at least one processor EC11 and the memory circuitry EC12 are electrically mounted on the at least one circuit board EC13. The at least one processor EC11 is coupled to the memory circuitry EC12. The memory circuitry EC12 is coupled to the at least one processor EC11. The at least one processor EC11 is electrically connected to the memory circuitry EC12 via the at least one circuit board EC13 and the at least one system bus EC14. The memory circuitry EC12 is electrically connected to the at least one processor EC11 via the at least one circuit board EC13 and the at least one system bus EC14. For example, the controller circuitry EC1 includes at least one semiconductor. The at least one processor EC11 includes at least one semiconductor. The memory circuitry EC12 includes at least one semiconductor.

For example, the at least one processor EC11 includes at least one of a central processing unit (CPU), a micro processing unit (MPU), a graphics processing unit (GPU), and a memory controller. The memory circuitry EC12 is electrically connected to the at least one processor EC11. For example, the memory circuitry EC12 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory circuitry EC12 includes storage areas each having an address. The at least one processor EC11 is configured to control the memory circuitry EC12 to store data in the storage areas of the memory circuitry EC12 and reads data from the storage areas of the memory circuitry EC12. The at least one processor EC11 can also be referred to as at least one hardware processor EC11, at least one processor circuit EC11, or processor circuitry EC11. The memory circuitry EC12 can also be referred to as at least one hardware memory EC12 or at least one memory circuit EC12. The memory circuitry EC12 can also be referred to as a non-transitory computer-readable storage medium EC12. Namely, the controller circuitry EC1 includes the non-transitory computer-readable storage medium EC12.

The controller circuitry EC1 is configured to execute at least one control algorithm of the human-powered vehicle component BC1. For example, the controller circuitry EC1 is programed to execute at least one control algorithm of the human-powered vehicle component BC1. The memory circuitry EC12 stores at least one program including at least one computer program code. The at least one program is read into the at least one processor EC11, and thereby the at least one control algorithm of the human-powered vehicle component BC1 is executed based on the at least one program.

The structure of the controller circuitry EC1 is not limited to the above structure. The structure of the controller circuitry EC1 is not limited to the at least one processor EC11 and the memory circuitry EC12. The controller circuitry EC1 can be realized by hardware alone, software alone, or a combination of hardware and software. In the present embodiment, the at least one processor EC11 and the memory circuitry EC12 can be separate chips. Alternatively, the at least one processor EC11 and the memory circuitry EC12 can be integrated as a single chip such as an application specific integrated circuit (ASIC) or a field programmable gate array (FPGA).

The controller circuitry EC1 can include at least two electronic controller circuits which are separately provided. The at least one control algorithm of the human-powered vehicle component BC1 can be executed by the at least two electronic controller circuits if needed or desired. The controller circuitry EC1 can include at least two processors which are separately provided. The controller circuitry EC1 can include at least two memories which are separately provided. The at least one control algorithm of the human-powered vehicle component BC1 can be executed by the at least two processors if needed or desired. The at least one control algorithm of the human-powered vehicle component BC1 can be stored in the at least two memories if needed or desired. The controller circuitry EC1 can include at least two circuit boards which are separately provided if needed or desired. The controller circuitry EC1 can include at least two system buses which are separately provided if needed or desired.

The first wireless communicator circuitry WC11 is electrically mounted on the at least one circuit board EC13. The first wireless communicator circuitry WC11 is configured to wirelessly communicate with another wireless communicator. For example, the first wireless communicator circuitry WC11 includes first signal transmitting circuitry, first signal receiving circuitry, and first antenna circuitry. The first signal transmitting circuitry is electrically connected to the first antenna circuitry. The first signal receiving circuitry is electrically connected to the first antenna circuitry. The first wireless communicator circuitry WC11 can also be referred to as a first wireless communicator WC11 or first wireless circuitry WC11.

The first wireless communicator circuitry WC11 is configured to transmit wireless signals via the first antenna circuitry. The first wireless communicator circuitry WC11 is configured to superimpose digital signals on carrier wave using a predetermined communication protocol to wirelessly transmit signals. In the present embodiment, the first wireless communicator circuitry WC11 is configured to encrypt signals using a cryptographic key to generate encrypted wireless signals.

The first wireless communicator circuitry WC11 is configured to receive wireless signals via the first antenna circuitry. In the present embodiment, the first wireless communicator circuitry WC11 is configured to decode the wireless signals to recognize signals transmitted from other wireless communicators. The first wireless communicator circuitry WC11 is configured to decrypt the wireless signals using the cryptographic key.

The first wireless communicator circuitry WC11 includes signal amplifier circuitry. The signal amplifier circuitry is coupled to the first signal transmitting circuitry, the first signal receiving circuitry, and the first antenna circuitry. The signal amplifier circuitry is configured to selectively amplify the signals of the first antenna circuitry. The signal amplifier circuitry can be controlled by the controller circuitry EC1. The controller circuitry EC1 can be configured to control the signal amplifier circuitry such that the signal amplifier circuitry operates in a low-power or high-power consumption state.

The human-powered vehicle component BC1 can include wired communicator circuitry. In such a modification, for example, the wired communicator circuitry is electrically connected to the controller circuitry EC1. The wired communicator circuitry is configured to communicate with another wired communicator circuitry via an electrical cable. For example, the wired communicator circuitry is configured to communicate with a wired communicator of the gear changer 12, the suspension 16, the suspension 18, the assist drive unit 22, or the adjustable seatpost 20 via an electrical cable.

The wired communicator circuitry is configured to communicate with another wired communicator using power line communication (PLC) technology. For example, the electrical cable includes a ground line and a voltage line that are detachably connected to a serial bus that is formed by communication interfaces. The wired communicator circuitry is configured to communicate with another wired communicator circuitry through the voltage line using the PLC technology. Since the PLC technology has been known, it will not be described in detail here for the sake of brevity.

The second wireless communicator circuitry WC12 is electrically mounted on the at least one circuit board EC13. The second wireless communicator circuitry WC12 is configured to wirelessly communicate with another wireless communicator. For example, the second wireless communicator circuitry WC12 includes second signal transmitting circuitry, second signal receiving circuitry, and second antenna circuitry. The second signal transmitting circuitry is electrically connected to the second antenna circuitry. The second signal receiving circuitry is electrically connected to the second antenna circuitry. The second wireless communicator circuitry WC12 can also be referred to as a second wireless communicator WC12 or second wireless circuitry WC12.

The second wireless communicator circuitry WC12 is configured to transmit wireless signals via the second antenna circuitry. The second wireless communicator circuitry WC12 is configured to superimpose digital signals on carrier wave using a predetermined communication protocol to wirelessly transmit signals. In the present embodiment, the second wireless communicator circuitry WC12 is configured to encrypt signals using a cryptographic key to generate encrypted wireless signals.

The second wireless communicator circuitry WC12 is configured to receive wireless signals via the second antenna circuitry. In the present embodiment, the second wireless communicator circuitry WC12 is configured to decode the wireless signals to recognize signals transmitted from other wireless communicators. The second wireless communicator circuitry WC12 is configured to decrypt the wireless signals using the cryptographic key.

The second wireless communicator circuitry WC12 includes signal amplifier circuitry. The signal amplifier circuitry is coupled to the second signal transmitting circuitry, the second signal receiving circuitry, and the second antenna circuitry. The signal amplifier circuitry is configured to selectively amplify the signals of the second antenna circuitry. The signal amplifier circuitry can be controlled by the controller circuitry EC1. The controller circuitry EC1 can be configured to control the signal amplifier circuitry such that the signal amplifier circuitry operates in a low-power or high-power consumption state.

The human-powered vehicle component BC1 can include wired communicator circuitry. In such a modification, for example, the wired communicator circuitry is electrically connected to the controller circuitry EC1. The wired communicator circuitry is configured to communicate with another wired communicator circuitry via an electrical cable. For example, the wired communicator circuitry is configured to communicate with a wired communicator of the gear changer 12, the suspension 16, the suspension 18, the assist drive unit 22, or the adjustable seatpost 20 via an electrical cable.

The wired communicator circuitry is configured to communicate with another wired communicator using power line communication (PLC) technology. For example, the electrical cable includes a ground line and a voltage line that are detachably connected to a serial bus that is formed by communication interfaces. The wired communicator circuitry is configured to communicate with another wired communicator circuitry through the voltage line using the PLC technology. Since the PLC technology has been known, it will not be described in detail here for the sake of brevity.

As seen in FIG. 11, the human-powered vehicle component BC1 includes a notification device BC12. The notification device BC12 is configured to be controlled by the controller circuitry EC1. Here, the notification device BC12 includes a light emitter configured to emit light. For example, the notification device BC12 includes one or more light emitting diodes (LEDs).

In the present embodiment, the human-powered vehicle component BC1 includes a power source holder BC16. The power source holder BC16 is configured to detachably and reattachably hold an electric power source BC15. Examples of the electric power source BC15 includes a primary battery and a secondary battery. The power source holder BC16 is configured to be electrically connected to the controller circuitry EC1, the wireless communicator circuitry WC1, and other electronic parts of the human-powered vehicle component BC1.

The electric power source BC15 is configured to supply electrical power to the controller circuitry EC1, the wireless communicator circuitry WC1, and other electronic parts of the human-powered vehicle component BC1 via the power source holder BC16. The human-powered vehicle component BC1 can be configured to be powered by another electric power source electrically connected to the human-powered vehicle component BC1 via an electric cable if needed or desired.

As seen in FIG. 11, the first additional human-powered vehicle component BC3 comprises first additional wireless communicator circuitry WC3. The first additional human-powered vehicle component BC3 further comprises first additional controller circuitry EC3. The first additional controller circuitry EC3 is electrically connected to the first additional wireless communicator circuitry WC3.

The first additional wireless communicator circuitry WC3 is configured to wirelessly communicate with another wireless communicator circuitry. The first additional controller circuitry EC3 is electrically connected to the first additional wireless communicator circuitry WC3 to control the first additional wireless communicator circuitry WC3.

The first additional controller circuitry EC3 includes at least one processor EC31 and memory circuitry EC32. The first additional human-powered vehicle component BC3 includes at least one circuit board EC33 and at least one system bus EC34. The first additional controller circuitry EC3 is electrically mounted on the at least one circuit board EC33. The at least one processor EC31 and the memory circuitry EC32 are electrically mounted on the at least one circuit board EC33. The at least one processor EC31 is coupled to the memory circuitry EC32. The memory circuitry EC32 is coupled to the at least one processor EC31. The at least one processor EC31 is electrically connected to the memory circuitry EC32 via the at least one circuit board EC33 and the at least one system bus EC34. The memory circuitry EC32 is electrically connected to the at least one processor EC31 via the at least one circuit board EC33 and the at least one system bus EC34. For example, the first additional controller circuitry EC3 includes at least one semiconductor. The at least one processor EC31 includes at least one semiconductor. The memory circuitry EC32 includes at least one semiconductor.

For example, the at least one processor EC31 includes at least one of a central processing unit (CPU), a micro processing unit (MPU), a graphics processing unit (GPU), and a memory controller. The memory circuitry EC32 is electrically connected to the at least one processor EC31. For example, the memory circuitry EC32 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory circuitry EC32 includes storage areas each having an address. The at least one processor EC31 is configured to control the memory circuitry EC32 to store data in the storage areas of the memory circuitry EC32 and reads data from the storage areas of the memory circuitry EC32. The at least one processor EC31 can also be referred to as at least one hardware processor EC31, at least one processor circuit EC31, or processor circuitry EC31. The memory circuitry EC32 can also be referred to as at least one hardware memory EC32 or at least one memory circuit EC32. The memory circuitry EC32 can also be referred to as a non-transitory computer-readable storage medium EC32. Namely, the first additional controller circuitry EC3 includes the non-transitory computer-readable storage medium EC32.

The first additional controller circuitry EC3 is configured to execute at least one control algorithm of the first additional human-powered vehicle component BC3. For example, the first additional controller circuitry EC3 is programed to execute at least one control algorithm of the first additional human-powered vehicle component BC3. The memory circuitry EC32 stores at least one program including at least one computer program code. The at least one program is read into the at least one processor EC31, and thereby the at least one control algorithm of the first additional human-powered vehicle component BC3 is executed based on the at least one program.

The structure of the first additional controller circuitry EC3 is not limited to the above structure. The structure of the first additional controller circuitry EC3 is not limited to the at least one processor EC31 and the memory circuitry EC32. The first additional controller circuitry EC3 can be realized by hardware alone or a combination of hardware and software. In the present embodiment, the at least one processor EC31 and the memory circuitry EC32 can be separate chips. Alternatively, the at least one processor EC31 and the memory circuitry EC32 can be integrated as a single chip such as an application specific integrated circuit (ASIC) or a field programmable gate array (FPGA).

The first additional controller circuitry EC3 can include at least two electronic controller circuits which are separately provided. The at least one control algorithm of the first additional human-powered vehicle component BC3 can be executed by the at least two electronic controller circuits if needed or desired. The first additional controller circuitry EC3 can include at least two processors which are separately provided. The first additional controller circuitry EC3 can include at least two memories which are separately provided. The at least one control algorithm of the first additional human-powered vehicle component BC3 can be executed by the at least two processors if needed or desired. The at least one control algorithm of the first additional human-powered vehicle component BC3 can be stored in the at least two memories if needed or desired. The first additional controller circuitry EC3 can include at least two circuit boards which are separately provided if needed or desired. The first additional controller circuitry EC3 can include at least two system buses which are separately provided if needed or desired.

The first additional wireless communicator circuitry WC3 is electrically mounted on the at least one circuit board EC33. The first additional wireless communicator circuitry WC3 is configured to wirelessly communicate with another wireless communicator. For example, the first additional wireless communicator circuitry WC3 includes first additional signal transmitting circuitry, first additional signal receiving circuitry, and first additional antenna circuitry. The first additional signal transmitting circuitry is electrically connected to the first additional antenna circuitry. The first additional signal receiving circuitry is electrically connected to the first additional antenna circuitry. The first additional wireless communicator circuitry WC3 can also be referred to as a wireless communicator WC3 or wireless circuitry WC3.

The first additional wireless communicator circuitry WC3 is configured to transmit wireless signals via the first additional antenna circuitry. The first additional wireless communicator circuitry WC3 is configured to superimpose digital signals on carrier wave using a predetermined communication protocol to wirelessly transmit signals. In the present embodiment, the first additional wireless communicator circuitry WC3 is configured to encrypt signals using a cryptographic key to generate encrypted wireless signals.

The first additional wireless communicator circuitry WC3 is configured to receive wireless signals via the first additional antenna circuitry. In the present embodiment, the first additional wireless communicator circuitry WC3 is configured to decode the wireless signals to recognize signals transmitted from other wireless communicators. The first additional wireless communicator circuitry WC3 is configured to decrypt the wireless signals using the cryptographic key.

The first additional wireless communicator circuitry WC3 includes first additional signal amplifier circuitry. The first additional signal amplifier circuitry is coupled to the first additional signal transmitting circuitry, the first additional signal receiving circuitry, and the first additional antenna circuitry. The first additional signal amplifier circuitry is configured to selectively amplify the signals of the first additional antenna circuitry. The first additional signal amplifier circuitry can be controlled by the first additional controller circuitry EC3. The first additional controller circuitry EC3 can be configured to control the first additional signal amplifier circuitry such that the first additional signal amplifier circuitry operates in a low-power or high-power consumption state.

The first additional wireless communicator circuitry WC3 can include wired communicator circuitry. In such a modification, for example, the wired communicator circuitry is electrically connected to the first additional controller circuitry EC3. The wired communicator circuitry is configured to communicate with another wired communicator circuitry via an electrical cable. For example, the wired communicator circuitry is configured to communicate with a wired communicator of the operating device 24 or 26 via an electrical cable.

The wired communicator circuitry is configured to communicate with another wired communicator using power line communication (PLC) technology. For example, the electrical cable includes a ground line and a voltage line that are detachably connected to a serial bus that is formed by communication interfaces. The wired communicator circuitry is configured to communicate with another wired communicator circuitry through the voltage line using the PLC technology. Since the PLC technology has been known, it will not be described in detail here for the sake of brevity.

As seen in FIG. 11, the first additional human-powered vehicle component BC3 includes a notification device BC32. The notification device BC32 is configured to be controlled by the first additional controller circuitry EC3. Here, the notification device BC32 includes a light emitter configured to emit light. For example, the notification device BC32 includes one or more light emitting diodes (LEDs). The notification device BC32 is configured to indicate a state of the first additional human-powered vehicle component BC3. For example, the notification device BC32 is configured to indicate a state of signal transmission and a mode such as a pairing mode.

In the present embodiment, the first additional human-powered vehicle component BC3 includes a power source holder BC36. The power source holder BC36 is configured to detachably and reattachably hold an electric power source BC35. Examples of the electric power source BC35 includes a primary battery and a secondary battery. The power source holder BC36 is configured to be electrically connected to the first additional controller circuitry EC3, the first additional wireless communicator circuitry WC3, and other electronic parts of the first additional human-powered vehicle component BC3. The power source holder BC36 is configured to be electrically connected to the electric actuator 12E and other electronic parts of the gear changer 12 in a case where the first additional human-powered vehicle component BC3 includes the gear changer 12.

The electric power source BC35 is configured to supply electrical power to the first additional controller circuitry EC3, the first additional wireless communicator circuitry WC3, and other electronic parts of the first additional human-powered vehicle component BC3 via the power source holder BC36. The electric power source BC35 is configured to supply electrical power to the electric actuator 12E and other electronic parts of the gear changer 12 via the power source holder BC36 in a case where the first additional human-powered vehicle component BC3 includes the gear changer 12. The first additional human-powered vehicle component BC3 can be configured to be powered by another electric power source electrically connected to the first additional human-powered vehicle component BC3 via an electric cable if needed or desired.

As seen in FIG. 11, the first additional human-powered vehicle component BC3 further comprises first additional user interface circuitry BC31 configured to receive a first additional user input U3. The first additional controller circuitry EC3 is electrically connected to the first additional user interface circuitry BC31 to detect the first additional user input U3 received by the first additional user interface circuitry BC31. Examples of the first additional user interface circuitry BC31 include a switch. The first additional user input U3 indicates at least one of an on-operation, an off-operation, transmission of a signal, and a change in a state of the first additional human-powered vehicle component BC3. The first additional user interface circuitry BC31 can be omitted from the first additional human-powered vehicle component BC3 if needed or desired.

As seen in FIG. 11, the second additional human-powered vehicle component BC4 comprises second additional wireless communicator circuitry WC4. The second additional human-powered vehicle component BC4 further comprises second additional controller circuitry EC4. The second additional controller circuitry EC4 is electrically connected to the second additional wireless communicator circuitry WC4.

The second additional wireless communicator circuitry WC4 is configured to wirelessly communicate with another wireless communicator circuitry. The second additional controller circuitry EC4 is electrically connected to the second additional wireless communicator circuitry WC4 to control the second additional wireless communicator circuitry WC4.

The second additional controller circuitry EC4 includes at least one processor EC41 and memory circuitry EC42. The second additional human-powered vehicle component BC4 includes at least one circuit board EC43 and at least one system bus EC44. The second additional controller circuitry EC4 is electrically mounted on the at least one circuit board EC43. The at least one processor EC41 and the memory circuitry EC42 are electrically mounted on the at least one circuit board EC43. The at least one processor EC41 is coupled to the memory circuitry EC42. The memory circuitry EC42 is coupled to the at least one processor EC41. The at least one processor EC41 is electrically connected to the memory circuitry EC42 via the at least one circuit board EC43 and the at least one system bus EC44. The memory circuitry EC42 is electrically connected to the at least one processor EC41 via the at least one circuit board EC43 and the at least one system bus EC44. For example, the second additional controller circuitry EC4 includes at least one semiconductor. The at least one processor EC41 includes at least one semiconductor. The memory circuitry EC42 includes at least one semiconductor.

For example, the at least one processor EC41 includes at least one of a central processing unit (CPU), a micro processing unit (MPU), a graphics processing unit (GPU), and a memory controller. The memory circuitry EC42 is electrically connected to the at least one processor EC41. For example, the memory circuitry EC42 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory circuitry EC42 includes storage areas each having an address. The at least one processor EC41 is configured to control the memory circuitry EC42 to store data in the storage areas of the memory circuitry EC42 and reads data from the storage areas of the memory circuitry EC42. The at least one processor EC41 can also be referred to as at least one hardware processor EC41, at least one processor circuit EC41, or processor circuitry EC41. The memory circuitry EC42 can also be referred to as at least one hardware memory EC42 or at least one memory circuit EC42. The memory circuitry EC42 can also be referred to as a non-transitory computer-readable storage medium EC42. Namely, the second additional controller circuitry EC4 includes the non-transitory computer-readable storage medium EC42.

The second additional controller circuitry EC4 is configured to execute at least one control algorithm of the second additional human-powered vehicle component BC4. For example, the second additional controller circuitry EC4 is programed to execute at least one control algorithm of the second additional human-powered vehicle component BC4. The memory circuitry EC42 stores at least one program including at least one computer program code. The at least one program is read into the at least one processor EC41, and thereby the at least one control algorithm of the second additional human-powered vehicle component BC4 is executed based on the at least one program.

The structure of the second additional controller circuitry EC4 is not limited to the above structure. The structure of the second additional controller circuitry EC4 is not limited to the at least one processor EC41 and the memory circuitry EC42. The second additional controller circuitry EC4 can be realized by hardware alone or a combination of hardware and software. In the present embodiment, the at least one processor EC41 and the memory circuitry EC42 can be separate chips. Alternatively, the at least one processor EC41 and the memory circuitry EC42 can be integrated as a single chip such as an application specific integrated circuit (ASIC) or a field programmable gate array (FPGA).

The second additional controller circuitry EC4 can include at least two electronic controller circuits which are separately provided. The at least one control algorithm of the second additional human-powered vehicle component BC4 can be executed by the at least two electronic controller circuits if needed or desired. The second additional controller circuitry EC4 can include at least two processors which are separately provided. The second additional controller circuitry EC4 can include at least two memories which are separately provided. The at least one control algorithm of the second additional human-powered vehicle component BC4 can be executed by the at least two processors if needed or desired. The at least one control algorithm of the second additional human-powered vehicle component BC4 can be stored in the at least two memories if needed or desired. The second additional controller circuitry EC4 can include at least two circuit boards which are separately provided if needed or desired. The second additional controller circuitry EC4 can include at least two system buses which are separately provided if needed or desired.

The second additional wireless communicator circuitry WC4 is electrically mounted on the at least one circuit board EC43. The second additional wireless communicator circuitry WC4 is configured to wirelessly communicate with another wireless communicator. For example, the second additional wireless communicator circuitry WC4 includes second additional signal transmitting circuitry, second additional signal receiving circuitry, and second additional antenna circuitry. The second additional signal transmitting circuitry is electrically connected to the second additional antenna circuitry. The second additional signal receiving circuitry is electrically connected to the second additional antenna circuitry. The second additional wireless communicator circuitry WC4 can also be referred to as a wireless communicator WC4 or wireless circuitry WC4.

The second additional wireless communicator circuitry WC4 is configured to transmit wireless signals via the second additional antenna circuitry. The second additional wireless communicator circuitry WC4 is configured to superimpose digital signals on carrier wave using a predetermined communication protocol to wirelessly transmit signals. In the present embodiment, the second additional wireless communicator circuitry WC4 is configured to encrypt signals using a cryptographic key to generate encrypted wireless signals.

The second additional wireless communicator circuitry WC4 is configured to receive wireless signals via the second additional antenna circuitry. In the present embodiment, the second additional wireless communicator circuitry WC4 is configured to decode the wireless signals to recognize signals transmitted from other wireless communicators. The second additional wireless communicator circuitry WC4 is configured to decrypt the wireless signals using the cryptographic key.

The second additional wireless communicator circuitry WC4 includes second additional signal amplifier circuitry. The second additional signal amplifier circuitry is coupled to the second additional signal transmitting circuitry, the second additional signal receiving circuitry, and the second additional antenna circuitry. The second additional signal amplifier circuitry is configured to selectively amplify the signals of the second additional antenna circuitry. The second additional signal amplifier circuitry can be controlled by the second additional controller circuitry EC4. The second additional controller circuitry EC4 can be configured to control the second additional signal amplifier circuitry such that the second additional signal amplifier circuitry operates in a low-power or high-power consumption state.

The second additional wireless communicator circuitry WC4 can include wired communicator circuitry. In such a modification, for example, the wired communicator circuitry is electrically connected to the second additional controller circuitry EC4. The wired communicator circuitry is configured to communicate with another wired communicator circuitry via an electrical cable. For example, the wired communicator circuitry is configured to communicate with a wired communicator of the operating device 24 or 26 via an electrical cable.

The wired communicator circuitry is configured to communicate with another wired communicator using power line communication (PLC) technology. For example, the electrical cable includes a ground line and a voltage line that are detachably connected to a serial bus that is formed by communication interfaces. The wired communicator circuitry is configured to communicate with another wired communicator circuitry through the voltage line using the PLC technology. Since the PLC technology has been known, it will not be described in detail here for the sake of brevity.

As seen in FIG. 11, the second additional human-powered vehicle component BC4 includes a notification device BC42. The notification device BC42 is configured to be controlled by the second additional controller circuitry EC4. Here, the notification device BC42 includes a light emitter configured to emit light. For example, the notification device BC42 includes one or more light emitting diodes (LEDs). The notification device BC42 is configured to indicate a state of the second additional human-powered vehicle component BC4. For example, the notification device BC42 is configured to indicate a state of signal transmission and a mode such as a pairing mode.

In the present embodiment, the second additional human-powered vehicle component BC4 includes a power source holder BC46. The power source holder BC46 is configured to detachably and reattachably hold an electric power source BC45. Examples of the electric power source BC45 includes a primary battery and a secondary battery. The power source holder BC46 is configured to be electrically connected to the second additional controller circuitry EC4, the second additional wireless communicator circuitry WC4, and other electronic parts of the second additional human-powered vehicle component BC4. The power source holder BC46 is configured to be electrically connected to the electric actuator 16E, the electric actuator 16G, and other electronic parts of the suspension 16 in a case where the second additional human-powered vehicle component BC4 includes the suspension 16.

The electric power source BC45 is configured to supply electrical power to the second additional controller circuitry EC4, the second additional wireless communicator circuitry WC4, and other electronic parts of the second additional human-powered vehicle component BC4 via the power source holder BC46. The electric power source BC45 is configured to supply electrical power to the electric actuator 16E, the state changing structure 16F, the state changing structure 16H, and other electronic parts of the suspension 16 via the power source holder BC46 in a case where the second additional human-powered vehicle component BC4 includes the suspension 16. The second additional human-powered vehicle component BC4 can be configured to be powered by another electric power source electrically connected to the second additional human-powered vehicle component BC4 via an electric cable if needed or desired.

The second additional human-powered vehicle component BC4 further comprises second additional user interface circuitry BC41 configured to receive a second additional user input U4. The second additional controller circuitry EC4 is electrically connected to the second additional user interface circuitry BC41 to detect the second additional user input U4 received by the second additional user interface circuitry BC41. Examples of the second additional user interface circuitry BC41 include a switch. The second additional user input U4 indicates at least one of an on-operation, an off-operation, transmission of a signal, and a change in a state of the second additional human-powered vehicle component BC4. The second additional user interface circuitry BC41 can be omitted from the second additional human-powered vehicle component BC4 if needed or desired.

In the present application, the term “wireless communicator” or “wireless communicator circuitry” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. Here, at least one of the wireless communicator circuitry WC1, the first wireless communicator circuitry WC11, the second wireless communicator circuitry WC12, the first additional wireless communicator circuitry WC3, and the second additional wireless communicator circuitry WC4 is configured to at least receive a wireless signal. For example, each of the wireless communicator circuitry WC1, the first wireless communicator circuitry WC11, the second wireless communicator circuitry WC12, the first additional wireless communicator circuitry WC3, and the second additional wireless communicator circuitry WC4 includes a two-way wireless transceiver that conducts two-way wireless communications using the wireless receiver for wirelessly receiving signals and a wireless transmitter for wirelessly transmitting signals.

Each of the wireless communicator circuitry WC1, the first wireless communicator circuitry WC11, the second wireless communicator circuitry WC12, the first additional wireless communicator circuitry WC3, and the second additional wireless communicator circuitry WC4 can use radio frequency (RF) signals, ultra-wide band communication signals, radio frequency identification (RFID), Wi-Fi (registered trademark), Zigbee (registered trademark), ANT+(registered trademark), or Bluetooth (registered trademark) or any other type of communication protocols suitable for short range wireless communications as understood in the human-powered vehicle field.

It should also be understood that each of the wireless communicator circuitry WC1, the first wireless communicator circuitry WC11, the second wireless communicator circuitry WC12, the first additional wireless communicator circuitry WC3, and the second additional wireless communicator circuitry WC4 can transmit the signals at a particular or randomly selected frequency and/or with an identifier such as a particular code, to distinguish the wireless signal from other wireless signals. In this way, each of the human-powered vehicle component BC1, the human-powered vehicle component BC2, the first additional human-powered vehicle component BC3, and the second additional human-powered vehicle component BC4 can recognize which signals are to be acted upon and which signals are not to be acted upon. Thus, each of the human-powered vehicle component BC1, the human-powered vehicle component BC2, the first additional human-powered vehicle component BC3, and the second additional human-powered vehicle component BC4 can ignore the signals from other wireless communicators of other electric devices.

As seen in FIG. 11, the human-powered vehicle component BC1 uses the first communication protocol and the second communication protocol different from the first communication protocol. The first additional human-powered vehicle component BC3 uses the first communication protocol. The second additional human-powered vehicle component BC4 uses the second communication protocol. Thus, the human-powered vehicle component BC1 is configured to be selectively paired with one of the first additional human-powered vehicle component BC3 and the second additional human-powered vehicle component BC4. The first additional human-powered vehicle component BC3 is configured to be paired with the human-powered vehicle component BC1. The second additional human-powered vehicle component BC4 is configured to be paired with the human-powered vehicle component BC1. The first additional human-powered vehicle component BC3 is configured not to be paired with the second additional human-powered vehicle component BC4 since the first communication protocol of the first additional human-powered vehicle component BC3 is different from the second communication protocol of the second additional human-powered vehicle component BC4.

The controller circuitry EC1 is configured to execute, using a first communication protocol or a second communication protocol, pairing between the human-powered vehicle component BC1 and another human-powered vehicle component such as the first additional human-powered vehicle component BC3 or the second additional human-powered vehicle component BC4. The second communication protocol is different from the first communication protocol. In the present embodiment, the human-powered vehicle component BC1 is free of a pairing mode. Alternatively, the controller circuitry EC1 can be configured to cause the human-powered vehicle component BC1 to enter a pairing mode. For example, the human-powered vehicle component BC1 can be configured to enter the pairing mode based on the first user input U1X or the second user input U1Z applied to the human-powered vehicle component BC1. Alternatively, the human-powered vehicle component BC1 can be configured to enter the pairing mode based on another trigger applied to the human-powered vehicle component BC1.

Such a trigger can include at least one of: supply of electrical power to the human-powered vehicle component BC1; connecting an electrical power source to the human-powered vehicle component BC1; connecting an electrical cable connected to another device; operating a device connected to or included in the human-powered vehicle component BC1; and an output of a sensor configured to obtain information relating to the human-powered vehicle B. Examples of the output of the sensor includes acceleration detected by an acceleration sensor, a cadence detected by a cadence sensor, and a vehicle speed detected by a speed sensor.

As seen in FIG. 11, the first additional human-powered vehicle component BC3 has a first listening mode and a first pairing mode. The first pairing mode is different from the first listening mode.

In the first listening mode, the first additional controller circuitry EC3 is configured to wirelessly scan a first pairing trigger signal using the first communication protocol via the first additional wireless communicator circuitry WC3. In the first listening mode, the first additional wireless communicator circuitry WC3 is configured to detect the first pairing trigger signal transmitted from another device.

For example, the first additional controller circuitry EC3 is configured to cause the first additional human-powered vehicle component BC3 to enter the first listening mode based on a first trigger applied to the first additional human-powered vehicle component BC3.

The first trigger includes at least one of: the first additional user input U3 received by the first additional user interface circuitry BC31; supply of electrical power to the first additional human-powered vehicle component BC3; connecting an electrical power source to the first additional human-powered vehicle component BC3; connecting an electrical cable connected to another device; operating a device connected to or included in the first additional human-powered vehicle component BC3; and an output of a sensor configured to obtain information relating to the human-powered vehicle B. Examples of the output of the sensor includes acceleration detected by an acceleration sensor, a cadence detected by a cadence sensor, and a vehicle speed detected by a speed sensor. For example, the first additional human-powered vehicle component BC3 is configured to enter the first pairing mode in response to the supply of electrical power to the first additional human-powered vehicle component BC3.

In the first listening mode, the first additional controller circuitry EC3 is configured to cause the first additional human-powered vehicle component BC3 to enter the first pairing mode in response to the first pairing trigger signal. In the first pairing mode, the first additional controller circuitry EC3 is configured to execute pairing between the first additional human-powered vehicle component BC3 and another human-powered vehicle component such as the human-powered vehicle component BC1 or the human-powered vehicle component BC2.

As seen in FIG. 11, the second additional human-powered vehicle component BC4 has a second listening mode and a second pairing mode. The second pairing mode is different from the second listening mode.

In the second listening mode, the second additional controller circuitry EC4 is configured to wirelessly scan a second pairing trigger signal using the second additional wireless communicator circuitry WC4. In the second listening mode, the second additional wireless communicator circuitry WC4 is configured to detect the second pairing trigger signal transmitted from another device.

For example, the second additional controller circuitry EC4 is configured to cause the second additional human-powered vehicle component BC4 to enter the second listening mode based on a second trigger applied to the second additional human-powered vehicle component BC4.

The second trigger includes at least one of: the second additional user input U4 received by the second additional user interface circuitry BC41; supply of electrical power to the second additional human-powered vehicle component BC4; connecting an electrical power source to the second additional human-powered vehicle component BC4; connecting an electrical cable connected to another device; operating a device connected to or included in the second additional human-powered vehicle component BC4; and an output of a sensor configured to obtain information relating to the human-powered vehicle B. Examples of the output of the sensor includes acceleration detected by an acceleration sensor, a cadence detected by a cadence sensor, and a vehicle speed detected by a speed sensor. For example, the second additional human-powered vehicle component BC4 is configured to enter the second pairing mode in response to the supply of electrical power to the second additional human-powered vehicle component BC4.

In the second listening mode, the second additional controller circuitry EC4 is configured to cause the second additional human-powered vehicle component BC4 to enter the second pairing mode in response to the second pairing trigger signal. In the second pairing mode, the second additional controller circuitry EC4 is configured to execute pairing between the second additional human-powered vehicle component BC4 and another human-powered vehicle component such as the human-powered vehicle component BC1, the human-powered vehicle component BC2, and the first additional human-powered vehicle component BC3.

As seen in FIG. 10, the memory circuitry EC12 is configured to store assignment information. The assignment information includes first assignment information indicating that the first user input U1X is assigned to the first communication protocol. The assignment information includes second assignment information indicating that the second user input U1Z is assigned to the second communication protocol.

The wireless communicator circuitry WC1 is configured to transmit a first wireless signal SG11 using the first communication protocol in response to the first user input U1X. For example, the wireless communicator circuitry WC1 is configured to transmit the first wireless signal SG11 to the first additional human-powered vehicle component BC3 using the first communication protocol in response to the first user input U1X. The controller circuitry EC1 is configured to control the wireless communicator circuitry WC1 to transmit the first wireless signal SG11 to another human-powered vehicle component such as the first additional human-powered vehicle component BC3 using the first communication protocol in response to the first user input U1X.

Specifically, the first wireless communicator circuitry WC11 is configured to transmit the first wireless signal SG11 using the first communication protocol in response to the first user input U1X. For example, the first wireless communicator circuitry WC11 is configured to transmit the first wireless signal SG11 to the first additional human-powered vehicle component BC3 using the first communication protocol in response to the first user input U1X. The controller circuitry EC1 is configured to control the first wireless communicator circuitry WC11 to transmit the first wireless signal SG11 to another human-powered vehicle component such as the first additional human-powered vehicle component BC3 using the first communication protocol in response to the first user input U1X.

The wireless communicator circuitry WC1 is configured to transmit the first wireless signal SG11 to the first additional human-powered vehicle component BC3 using the first communication protocol in response to the first user input U1X in an unpaired state where the human-powered vehicle component BC1 is paired with neither the first additional human-powered vehicle component BC3 nor the second additional human-powered vehicle component BC4. The controller circuitry EC1 is configured to control the wireless communicator circuitry WC1 to transmit the first wireless signal SG11 to the first additional human-powered vehicle component BC3 using the first communication protocol in response to the first user input U1X in the unpaired state.

As seen in FIG. 11, the wireless communicator circuitry WC1 is configured to be free of transmitting the first wireless signal SG11 using the first communication protocol in response to the second user input U1Z. The controller circuitry EC1 is configured to control the wireless communicator circuitry WC1 not to transmit the first wireless signal SG11 using the first communication protocol in response to the second user input U1Z. The wireless communicator circuitry WC1 is configured to be free of transmitting the first wireless signal SG11 using the first communication protocol in response to the second user input U1Z in the unpaired state. The controller circuitry EC1 is configured to control the wireless communicator circuitry WC1 to be free of transmitting the first wireless signal SG11 using the first communication protocol in response to the second user input U1Z in the unpaired state.

Specifically, the first wireless communicator circuitry WC11 is configured to be free of transmitting the first wireless signal SG11 using the first communication protocol in response to the second user input U1Z. The controller circuitry EC1 is configured to control the first wireless communicator circuitry WC11 not to transmit the first wireless signal SG11 using the first communication protocol in response to the second user input U1Z. The first wireless communicator circuitry WC11 is configured to be free of transmitting the first wireless signal SG11 using the first communication protocol in response to the second user input U1Z in the unpaired state. The controller circuitry EC1 is configured to control the first wireless communicator circuitry WC11 to be free of transmitting the first wireless signal SG11 using the first communication protocol in response to the second user input U1Z in the unpaired state.

In the present embodiment, the first wireless signal SG11 includes a first pairing start signal SG11A. The first pairing start signal SG11A has no specified recipient. For example, the first pairing start signal SG11A includes an advertisement signal having no specified recipient. The first pairing start signal SG11A can also be referred to as a first advertising signal. The first pairing start signal SG11A indicates that another human-powered vehicle component enters a pairing mode. For example, the first pairing start signal SG11A indicates that the first additional human-powered vehicle component BC3 enters the first pairing mode. Alternatively, the first pairing start signal SG11A can be free of indicating that the first additional human-powered vehicle component BC3 enters the first pairing mode.

The wireless communicator circuitry WC1 is configured to wirelessly transmit the first pairing start signal SG11A using the first communication protocol in response to the first user input U1X. For example, the wireless communicator circuitry WC1 is configured to wirelessly transmit the first pairing start signal SG11A to the first additional human-powered vehicle component BC3 using the first communication protocol in response to the first user input U1X. The controller circuitry EC1 is configured to control the wireless communicator circuitry WC1 to wirelessly transmit the first pairing start signal SG11A to another human-powered vehicle component such as the first additional human-powered vehicle component BC3 using the first communication protocol in response to the first user input U1X. Alternatively, the controller circuitry EC1 can be configured to control the wireless communicator circuitry WC1 to wirelessly transmit the first pairing start signal SG11A at predetermined intervals for a predetermined time in response to the first user input U1X.

Specifically, the first wireless communicator circuitry WC11 is configured to wirelessly transmit the first pairing start signal SG11A using the first communication protocol in response to the first user input U1X. For example, the first wireless communicator circuitry WC11 is configured to wirelessly transmit the first pairing start signal SG11A to the first additional human-powered vehicle component BC3 using the first communication protocol in response to the first user input U1X. The controller circuitry EC1 is configured to control the first wireless communicator circuitry WC11 to wirelessly transmit the first pairing start signal SG11A to another human-powered vehicle component such as the first additional human-powered vehicle component BC3 using the first communication protocol in response to the first user input U1X. Alternatively, the controller circuitry EC1 can be configured to control the first wireless communicator circuitry WC11 to wirelessly transmit the first pairing start signal SG11A at predetermined intervals for a predetermined time in response to the first user input U1X.

For example, the first pairing start signal SG11A can include pairing information ID11 of the human-powered vehicle component BC1. The controller circuitry EC1 is configured to store the pairing information ID11 in the memory circuitry EC12. The pairing information ID11 includes information relating to the human-powered vehicle component BC1. The pairing information ID11 includes at least one of identification information and first cryptographic key information. The identification information includes a unique number indicating the human-powered vehicle component BC1. Examples of the unique number include an address of the human-powered vehicle component BC1. The first cryptographic key information includes a cryptographic key. Another wireless communicator encrypts information using the first cryptographic key information, and the human-powered vehicle component BC1 decrypts the encrypted information using the first cryptographic key information. The first cryptographic key information of the pairing information ID11 corresponds to the first communication protocol used in the first additional human-powered vehicle component BC3 and the human-powered vehicle component BC1.

In the first listening mode, the first additional wireless communicator circuitry WC3 is configured to detect a wireless signal such as the first pairing start signal SG11A using the first communication protocol. In the first listening mode, the first additional wireless communicator circuitry WC3 is configured to wirelessly receive the first pairing start signal SG11A using the first communication protocol. In the first listening mode, the first additional controller circuitry EC3 is configured to recognize the first pairing start signal SG11A received by the first additional wireless communicator circuitry WC3. The first additional controller circuitry EC3 is configured to cause the first additional human-powered vehicle component BC3 to enter the first pairing mode in response to the first pairing start signal SG11A.

The first additional controller circuitry EC3 is configured to store, in the memory circuitry EC32, at least part of the pairing information ID11 included in the first pairing start signal SG11A in a case where the first additional wireless communicator circuitry WC3 detects the first pairing start signal SG11A in the first pairing mode. For example, the first additional controller circuitry EC3 is configured to store, in the memory circuitry EC32, the identification information included in the pairing information ID11 included in the first pairing start signal SG11A in the case where the first additional wireless communicator circuitry WC3 detects the first pairing start signal SG11A in the first pairing mode.

The first additional controller circuitry EC3 is configured to control the first additional wireless communicator circuitry WC3 to wirelessly transmit a first pairing demand signal SG31 using the first communication protocol after the start of the first pairing mode. The first additional controller circuitry EC3 can be configured to control the first additional wireless communicator circuitry WC3 to wirelessly transmit the first pairing demand signal SG31 at predetermined intervals for a predetermined time in the first pairing mode.

The wireless communicator circuitry WC1 is configured to scan a wireless signal such as the first pairing demand signal SG31 using the first communication protocol after the transmission of the first pairing start signal SG11A. The wireless communicator circuitry WC1 is configured to receive the first pairing demand signal SG31 transmitted wirelessly from the first additional human-powered vehicle component BC3 using the first communication protocol in response to the first pairing start signal SG11A. The controller circuitry EC1 is configured to recognize the first pairing demand signal SG31 via the wireless communicator circuitry WC1 using the first communication protocol.

Specifically, the first wireless communicator circuitry WC11 is configured to scan a wireless signal such as the first pairing demand signal SG31 using the first communication protocol after the transmission of the first pairing start signal SG11A. The first wireless communicator circuitry WC11 is configured to receive the first pairing demand signal SG31 transmitted wirelessly from the first additional human-powered vehicle component BC3 using the first communication protocol in response to the first pairing start signal SG11A. The controller circuitry EC1 is configured to recognize the first pairing demand signal SG31 via the first wireless communicator circuitry WC11 using the first communication protocol.

The first pairing demand signal SG31 includes first pairing information ID3 of the first additional human-powered vehicle component BC3. The first additional controller circuitry EC3 is configured to store the first pairing information ID3 in the memory circuitry EC32. The first pairing information ID3 includes at least one of first identification information and first additional cryptographic key information. In the present embodiment, for example, the first pairing demand signal SG31 includes the first identification information of the first pairing information ID3. The first identification information includes a unique number indicating the first additional human-powered vehicle component BC3. Examples of the unique number include an address of the first additional human-powered vehicle component BC3. The first additional cryptographic key information includes a first cryptographic key. Another wireless communicator encrypts information using the first additional cryptographic key information, and the first additional wireless communicator circuitry WC3 decrypts the encrypted information using the first additional cryptographic key information. The controller circuitry EC1 is configured to store the first pairing information ID3 in the memory circuitry EC12. The first additional cryptographic key information corresponds to the first communication protocol used in the first additional human-powered vehicle component BC3 and the human-powered vehicle component BC1.

The controller circuitry EC1 is configured to store, in the memory circuitry EC12, at least part of the first pairing information ID3 included in the first pairing demand signal SG31 in a case where the first additional wireless communicator circuitry WC3 detects the first pairing demand signal SG31 in the first pairing mode. For example, the controller circuitry EC1 is configured to store, in the memory circuitry EC12, the first identification information included in the first pairing information ID3 included in the first pairing demand signal SG31 in the case where the first additional wireless communicator circuitry WC3 detects the first pairing demand signal SG31.

In the present embodiment, the first additional wireless communicator circuitry WC3 is configured to automatically transmit the first pairing demand signal SG31 in response to the first pairing start signal SG11A in the first pairing mode. However, the first additional wireless communicator circuitry WC3 can be configured to wirelessly transmit the first pairing demand signal SG31 based on another trigger other than the first pairing start signal SG11A if needed or desired. For example, the user interface circuitry BC11 can be configured to receive a user operation indicating transmission of the first pairing demand signal SG31. The first additional wireless communicator circuitry WC3 can be configured to transmit the first pairing demand signal SG31 in response to the user operation in a state where the first additional wireless communicator circuitry WC3 receives the first pairing start signal SG11A.

The wireless communicator circuitry WC1 is configured to detect the first pairing demand signal SG31 transmitted from the first additional wireless communicator circuitry WC3. The controller circuitry EC1 is configured to store, in the memory circuitry EC12, at least part of the first pairing information ID3 included in the first pairing demand signal SG31 in a case where the wireless communicator circuitry WC1 detects the first pairing demand signal SG31. For example, the controller circuitry EC1 is configured to store, in the memory circuitry EC12, the first identification information and the first additional cryptographic key information which are included in the first pairing information ID3 included in the first pairing demand signal SG31 in a case where the wireless communicator circuitry WC1 detects the first pairing demand signal SG31.

Specifically, the first wireless communicator circuitry WC11 is configured to detect the first pairing demand signal SG31 transmitted from the first additional wireless communicator circuitry WC3. The controller circuitry EC1 is configured to store, in the memory circuitry EC12, at least part of the first pairing information ID3 included in the first pairing demand signal SG31 in a case where the first wireless communicator circuitry WC11 detects the first pairing demand signal SG31. For example, the controller circuitry EC1 is configured to store, in the memory circuitry EC12, the first identification information and the first additional cryptographic key information which are included in the first pairing information ID3 included in the first pairing demand signal SG31 in a case where the first wireless communicator circuitry WC11 detects the first pairing demand signal SG31.

As described above, the first additional human-powered vehicle component BC3 and the human-powered vehicle component BC1 are paired using the first communication protocol. The first additional controller circuitry EC3 is configured to cause the first additional human-powered vehicle component BC3 to exit the first pairing mode after the completion of the pairing process.

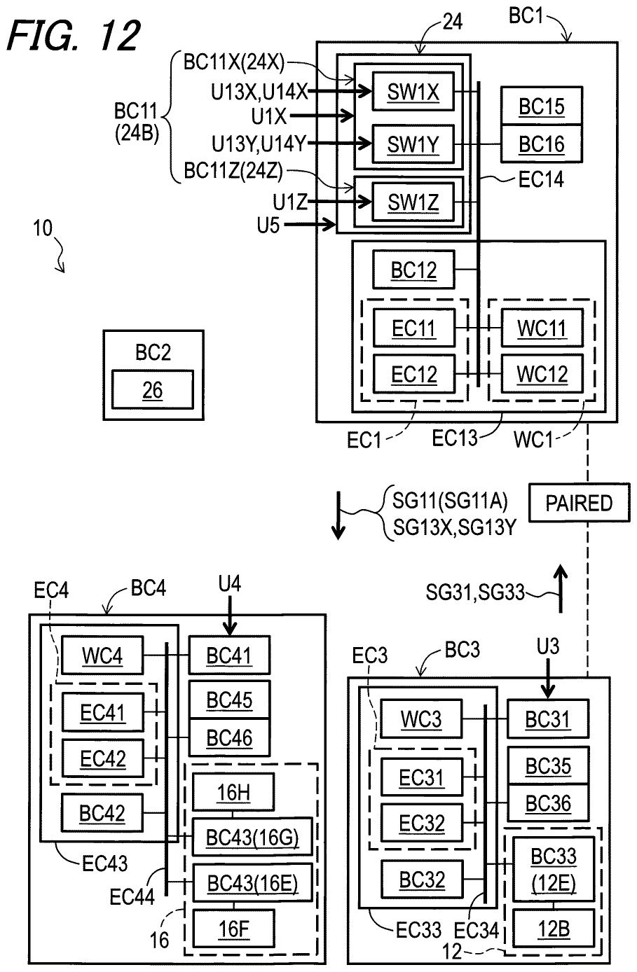

As seen in FIG. 12, the wireless communicator circuitry WC1 is configured to transmit a third wireless signal SG13X or SG13Y using the first communication protocol in response to the third user input U13X or U13Y in a first paired state where the human-powered vehicle component BC1 is paired with the first additional human-powered vehicle component BC3 using the first communication protocol. The controller circuitry EC1 is configured to control the wireless communicator circuitry WC1 to transmit the third wireless signal SG13X or SG13Y using the first communication protocol in response to the third user input U13X or U13Y in the first paired state. The wireless communicator circuitry WC1 can be configured to transmit the third wireless signal SG13X or SG13Y using a communication protocol different from the first communication protocol. In the first paired state, the human-powered vehicle component BC1 is paired with the first additional human-powered vehicle component BC3 using the first communication protocol while the human-powered vehicle component BC1 is not paired with the second additional human-powered vehicle component BC4.

Specifically, the first wireless communicator circuitry WC11 is configured to transmit the third wireless signal SG13X or SG13Y using the first communication protocol in response to the third user input U13X or U13Y in the first paired state. The controller circuitry EC1 is configured to control the first wireless communicator circuitry WC11 to transmit the third wireless signal SG13X or SG13Y using the first communication protocol in response to the third user input U13X or U13Y in the first paired state.

The third user input U13X or U13Y is different from the first user input U1X. The third wireless signal SG13X or SG13Y is different from the first wireless signal SG11. The third wireless signal SG13X or SG13Y is free of indicating pairing between the human-powered vehicle component BC1 and another device. The third wireless signal SG13X or SG13Y is free of a pairing start signal.

For example, the third wireless signal SG13X or SG13Y can include the pairing information ID11 of the human-powered vehicle component BC1. The pairing information ID11 included in the third wireless signal SG13X or SG13Y includes the identification information and the first cryptographic key information.

The first additional wireless communicator circuitry WC3 is configured to receive the third wireless signal SG13X or SG13Y using the first communication protocol in the first paired state. The first additional controller circuitry EC3 is configured to control the first additional wireless communicator circuitry WC3 to receive the third wireless signal SG13X or SG13Y using the first communication protocol in the first paired state. The first additional controller circuitry EC3 is configured to store the first cryptographic key information of the pairing information ID11 included in the third wireless signal SG13X or SG13Y in the memory circuitry EC32. The first additional wireless communicator circuitry WC3 is configured to encrypt signals using the first cryptographic key information to generate encrypted wireless signals after the receipt of the third wireless signal SG13X or SG13Y.

The first additional controller circuitry EC3 is configured to control the first electric actuator BC33 based on the third wireless signal SG13X or SG13Y. In a case where the human-powered vehicle component BC1 is paired with the first additional human-powered vehicle component BC3 including the gear changer 12, the third wireless signal SG13X indicates upshifting of the gear changer 12, and the third wireless signal SG13Y indicates downshifting of the gear changer 12. Thus, the first additional controller circuitry EC3 is configured to control the first electric actuator BC33 to move the chain guide 12D in an upshifting direction based on the third wireless signal SG13X. The first additional controller circuitry EC3 is configured to control the first electric actuator BC33 to move the chain guide 12D in a downshifting direction based on the third wireless signal SG13Y.

In a case where the human-powered vehicle component BC1 is paired with the first additional human-powered vehicle component BC3 including the suspension 16, the third wireless signal SG13X indicates changing of the damping property of the suspension 16, and the third wireless signal SG13Y indicates changing of the stroke of the suspension 16. Thus, the first additional controller circuitry EC3 is configured to control the first electric actuator BC33 to actuate the state changing structure 16F to change the damping property of the suspension 16 based on the third wireless signal SG13X. The first additional controller circuitry EC3 is configured to control the first electric actuator BC33 to actuate the state changing structure 16H to change the stroke of the suspension 16 based on the third wireless signal SG13Y.

The first additional wireless communicator circuitry WC3 is configured to wirelessly transmit a first acknowledgement signal SG33 using the first communication protocol in response to the third wireless signal SG13X or SG13Y in the first paired state. The first additional controller circuitry EC3 is configured to control the first additional wireless communicator circuitry WC3 to wirelessly transmit the first acknowledgement signal SG33 using the first communication protocol in response to the third wireless signal SG13X or SG13Y in the first paired state.

For example, the first acknowledgement signal SG33 can include the first pairing information ID3 of the first additional human-powered vehicle component BC3. The first pairing information ID3 included in the first acknowledgement signal SG33 includes the first identification information and the first additional cryptographic key information.

The first wireless communicator circuitry WC11 is configured to scan the first acknowledgement signal SG33 using the first communication protocol after the transmission of the third wireless signal SG13X or SG13Y. The controller circuitry EC1 is configured to control the first wireless communicator circuitry WC11 to scan the first acknowledgement signal SG33 using the first communication protocol after the transmission of the third wireless signal SG13X or SG13Y. The controller circuitry EC1 is configured to recognize the first acknowledgement signal SG33 via the first wireless communicator circuitry WC11 using the first communication protocol. The controller circuitry EC1 is configured to store the first additional cryptographic key information of the first acknowledgement signal SG33 included in the first acknowledgement signal SG33 in the memory circuitry EC12. The first wireless communicator circuitry WC11 is configured to encrypt signals using the first additional cryptographic key information to generate encrypted wireless signals after the receipt of the first acknowledgement signal SG33.

As seen in FIG. 11, the wireless communicator circuitry WC1 is configured to transmit a second wireless signal SG12 using the second communication protocol in response to the second user input U1Z. For example, the wireless communicator circuitry WC1 is configured to transmit the second wireless signal SG12 to the second additional human-powered vehicle component BC4 using the second communication protocol different from the first communication protocol in response to the second user input U1Z different from the first user input U1X. The controller circuitry EC1 is configured to control the wireless communicator circuitry WC1 to transmit the second wireless signal SG12 to another human-powered vehicle component such as the second additional human-powered vehicle component BC4 using the second communication protocol in response to the second user input U1Z.

Specifically, the second wireless communicator circuitry WC12 is configured to transmit the second wireless signal SG12 using the second communication protocol in response to the second user input U1Z. For example, the second wireless communicator circuitry WC12 is configured to transmit the second wireless signal SG12 to the second additional human-powered vehicle component BC4 using the second communication protocol different from the first communication protocol in response to the second user input U1Z different from the first user input U1X. The controller circuitry EC1 is configured to control the second wireless communicator circuitry WC12 to transmit the second wireless signal SG12 to another human-powered vehicle component such as the second additional human-powered vehicle component BC4 using the second communication protocol in response to the second user input U1Z.

The wireless communicator circuitry WC1 is configured to transmit the second wireless signal SG12 to the second additional human-powered vehicle component BC4 using the second communication protocol in response to the second user input U1Z in the unpaired state where the human-powered vehicle component is not paired with the second additional human-powered vehicle component BC4. The controller circuitry EC1 is configured to control the wireless communicator circuitry WC1 to transmit the second wireless signal SG12 to the second additional human-powered vehicle component BC4 using the second communication protocol in response to the second user input U1Z in the unpaired state.

Specifically, the second wireless communicator circuitry WC12 is configured to transmit the second wireless signal SG12 to the second additional human-powered vehicle component BC4 using the second communication protocol in response to the second user input U1Z in the unpaired state where the human-powered vehicle component is not paired with the second additional human-powered vehicle component BC4. The controller circuitry EC1 is configured to control the second wireless communicator circuitry WC12 to transmit the second wireless signal SG12 to the second additional human-powered vehicle component BC4 using the second communication protocol in response to the second user input U1Z in the unpaired state.

As seen in FIG. 12, the wireless communicator circuitry WC1 is configured to be free of transmitting the second wireless signal SG12 using the second communication protocol in response to the first user input U1X. The controller circuitry EC1 is configured to control the wireless communicator circuitry WC1 not to transmit the second wireless signal SG12 using the second communication protocol in response to the first user input U1X. The wireless communicator circuitry WC1 is configured to be free of transmitting the second wireless signal SG12 using the second communication protocol in response to the first user input U1X in the unpaired state. The controller circuitry EC1 is configured to control the wireless communicator circuitry WC1 to be free of transmitting the second wireless signal SG12 using the second communication protocol in response to the first user input U1X in the unpaired state.

Specifically, the second wireless communicator circuitry WC12 is configured to be free of transmitting the second wireless signal SG12 using the second communication protocol in response to the first user input U1X. The controller circuitry EC1 is configured to control the second wireless communicator circuitry WC12 not to transmit the second wireless signal SG12 using the second communication protocol in response to the first user input U1X. The second wireless communicator circuitry WC12 is configured to be free of transmitting the second wireless signal SG12 using the second communication protocol in response to the first user input U1X in the unpaired state. The controller circuitry EC1 is configured to control the second wireless communicator circuitry WC12 to be free of transmitting the second wireless signal SG12 using the second communication protocol in response to the first user input U1X in the unpaired state.

In the present embodiment, the second wireless signal SG12 includes a second pairing start signal SG12A. The second pairing start signal SG12A has no specified recipient. For example, the second pairing start signal SG12A includes an advertisement signal having no specified recipient. The second pairing start signal SG12A can also be referred to as a second advertising signal. The second pairing start signal SG12A indicates that another human-powered vehicle component enters a pairing mode. For example, the second pairing start signal SG12A indicates that the second additional human-powered vehicle component BC4 enters the second pairing mode. Alternatively, the second pairing start signal SG12A can be free of indicating that the second additional human-powered vehicle component BC4 enters the second pairing mode.

The wireless communicator circuitry WC1 is configured to wirelessly transmit the second pairing start signal SG12A using the second communication protocol in response to the second user input U1Z. For example, the wireless communicator circuitry WC1 is configured to wirelessly transmit the second pairing start signal SG12A to the second additional human-powered vehicle component BC4 using the second communication protocol in response to the second user input U1Z. The controller circuitry EC1 is configured to control the wireless communicator circuitry WC1 to wirelessly transmit the second pairing start signal SG12A to another human-powered vehicle component such as the second additional human-powered vehicle component BC4 using the second communication protocol in response to the second user input U1Z. Alternatively, the controller circuitry EC1 can be configured to control the wireless communicator circuitry WC1 to wirelessly transmit the second pairing start signal SG12A at predetermined intervals for a predetermined time in response to the second user input U1Z.

Specifically, the second wireless communicator circuitry WC12 is configured to wirelessly transmit the second pairing start signal SG12A using the second communication protocol in response to the second user input U1Z. For example, the second wireless communicator circuitry WC12 is configured to wirelessly transmit the second pairing start signal SG12A to the second additional human-powered vehicle component BC4 using the second communication protocol in response to the second user input U1Z. The controller circuitry EC1 is configured to control the second wireless communicator circuitry WC12 to wirelessly transmit the second pairing start signal SG12A to another human-powered vehicle component such as the second additional human-powered vehicle component BC4 using the second communication protocol in response to the second user input U1Z. Alternatively, the controller circuitry EC1 can be configured to control the second wireless communicator circuitry WC12 to wirelessly transmit the second pairing start signal SG12A at predetermined intervals for a predetermined time in response to the second user input U1Z.

For example, the second pairing start signal SG12A can include pairing information ID12 of the human-powered vehicle component BC1. The controller circuitry EC1 is configured to store the pairing information ID12 in the memory circuitry EC12. The pairing information ID12 includes information relating to the human-powered vehicle component BC1. The pairing information ID12 includes at least one of the identification information and second cryptographic key information. The identification information of the pairing information ID12 is the same as the identification information of the pairing information ID11. The second cryptographic key information includes a cryptographic key. Another wireless communicator encrypts information using the second cryptographic key information, and the human-powered vehicle component BC1 decrypts the encrypted information using the second cryptographic key information. The second cryptographic key information of the pairing information ID12 corresponds to the second communication protocol used in the second additional human-powered vehicle component BC4 and the human-powered vehicle component BC1.

In the second listening mode, the second additional wireless communicator circuitry WC4 is configured to detect a wireless signal such as the second pairing start signal SG12A using the second communication protocol. In the second listening mode, the second additional wireless communicator circuitry WC4 is configured to wirelessly receive the second pairing start signal SG12A using the second communication protocol. In the second listening mode, the second additional controller circuitry EC4 is configured to recognize the second pairing start signal SG12A received by the second additional wireless communicator circuitry WC4. The second additional controller circuitry EC4 is configured to cause the second additional human-powered vehicle component BC4 to enter the second pairing mode in response to the second pairing start signal SG12A.

The second additional controller circuitry EC4 is configured to store, in the memory circuitry EC42, at least part of the pairing information ID12 included in the second pairing start signal SG12A in a case where the second additional wireless communicator circuitry WC4 detects the second pairing start signal SG12A in the second pairing mode. For example, the second additional controller circuitry EC4 is configured to store, in the memory circuitry EC42, the identification information included in the pairing information ID12 included in the second pairing start signal SG12A in the case where the second additional wireless communicator circuitry WC4 detects the second pairing start signal SG12A in the second pairing mode.

The second additional controller circuitry EC4 is configured to control the second additional wireless communicator circuitry WC4 to wirelessly transmit a second pairing demand signal SG41 using the second communication protocol after the start of the second pairing mode. Alternatively, the second additional controller circuitry EC4 is configured to control the second additional wireless communicator circuitry WC4 to wirelessly transmit the second pairing demand signal SG41 at predetermined intervals for a predetermined time in the second pairing mode.

The wireless communicator circuitry WC1 is configured to scan a wireless signal such as the second pairing demand signal SG41 using the second communication protocol after the transmission of the second pairing start signal SG12A. The wireless communicator circuitry WC1 is configured to receive a second pairing demand signal SG41 transmitted wirelessly from the second additional human-powered vehicle component BC4 using the second communication protocol in response to the second pairing start signal SG12A. The controller circuitry EC1 is configured to recognize the second pairing demand signal SG41 via the wireless communicator circuitry WC1 using the second communication protocol.

The second wireless communicator circuitry WC12 is configured to scan a wireless signal such as the second pairing demand signal SG41 using the second communication protocol after the transmission of the second pairing start signal SG12A. The second wireless communicator circuitry WC12 is configured to receive a second pairing demand signal SG41 transmitted wirelessly from the second additional human-powered vehicle component BC4 using the second communication protocol in response to the second pairing start signal SG12A. The controller circuitry EC1 is configured to recognize the second pairing demand signal SG41 via the second wireless communicator circuitry WC12 using the second communication protocol.

The second pairing demand signal SG41 includes second pairing information ID4 of the second additional human-powered vehicle component BC4. The second additional controller circuitry EC4 is configured to store the second pairing information ID4 in the memory circuitry EC42. The second pairing information ID4 includes at least one of second identification information and second additional cryptographic key information. In the present embodiment, for example, the second pairing demand signal SG41 includes the second identification information of the second pairing information ID4. The second identification information includes a unique number indicating the second additional human-powered vehicle component BC4. Examples of the unique number include an address of the second additional human-powered vehicle component BC4. The second additional cryptographic key information includes a second cryptographic key. Another wireless communicator encrypts information using the second additional cryptographic key information, and the second additional wireless communicator circuitry WC4 decrypts the encrypted information using the second additional cryptographic key information. The controller circuitry EC1 is configured to store the second pairing information ID4 in the memory circuitry EC12. The second additional cryptographic key information corresponds to the second communication protocol used in the second additional human-powered vehicle component BC4 and the human-powered vehicle component BC1.

The controller circuitry EC1 is configured to store, in the memory circuitry EC12, at least part of the second pairing information ID4 included in the second pairing demand signal SG41 in a case where the second additional wireless communicator circuitry WC4 detects the second pairing demand signal SG41 in the second pairing mode. For example, the controller circuitry EC1 is configured to store, in the memory circuitry EC12, the identification information included in the second pairing information ID4 included in the second pairing demand signal SG41 in the case where the second additional wireless communicator circuitry WC4 detects the second pairing demand signal SG41.

In the present embodiment, the second additional wireless communicator circuitry WC4 is configured to automatically transmit the second pairing demand signal SG41 in response to the second pairing start signal SG12A in the second pairing mode. However, the second additional wireless communicator circuitry WC4 can be configured to wirelessly transmit the second pairing demand signal SG41 based on another trigger other than the second pairing start signal SG12A if needed or desired. For example, the user interface circuitry BC11 can be configured to receive a user operation indicating transmission of the second pairing demand signal SG41. The second additional wireless communicator circuitry WC4 can be configured to transmit the second pairing demand signal SG41 in response to the user operation in a state where the second additional wireless communicator circuitry WC4 receives the second pairing start signal SG12A.

The wireless communicator circuitry WC1 is configured to detect the second pairing demand signal SG41 transmitted from the second additional wireless communicator circuitry WC4. The controller circuitry EC1 is configured to store, in the memory circuitry EC12, the second pairing information ID4 included in the second pairing demand signal SG41 in a case where the wireless communicator circuitry WC1 detects the second pairing demand signal SG41. For example, the controller circuitry EC1 is configured to store, in the memory circuitry EC12, at least part of the second identification information and the second cryptographic key information which are included in the second pairing information ID4 included in the second pairing demand signal SG41 in a case where the wireless communicator circuitry WC1 detects the second pairing demand signal SG41.

The second wireless communicator circuitry WC12 is configured to detect the second pairing demand signal SG41 transmitted from the second additional wireless communicator circuitry WC4. The controller circuitry EC1 is configured to store, in the memory circuitry EC12, the second pairing information ID4 included in the second pairing demand signal SG41 in a case where the second wireless communicator circuitry WC12 detects the second pairing demand signal SG41. For example, the controller circuitry EC1 is configured to store, in the memory circuitry EC12, at least part of the second identification information and the second cryptographic key information which are included in the second pairing information ID4 included in the second pairing demand signal SG41 in a case where the second wireless communicator circuitry WC12 detects the second pairing demand signal SG41.

As described above, the second additional human-powered vehicle component BC4 and the human-powered vehicle component BC1 are paired using the second communication protocol. The second additional controller circuitry EC4 is configured to cause the second additional human-powered vehicle component BC4 to exit the second pairing mode after the completion of the pairing process.

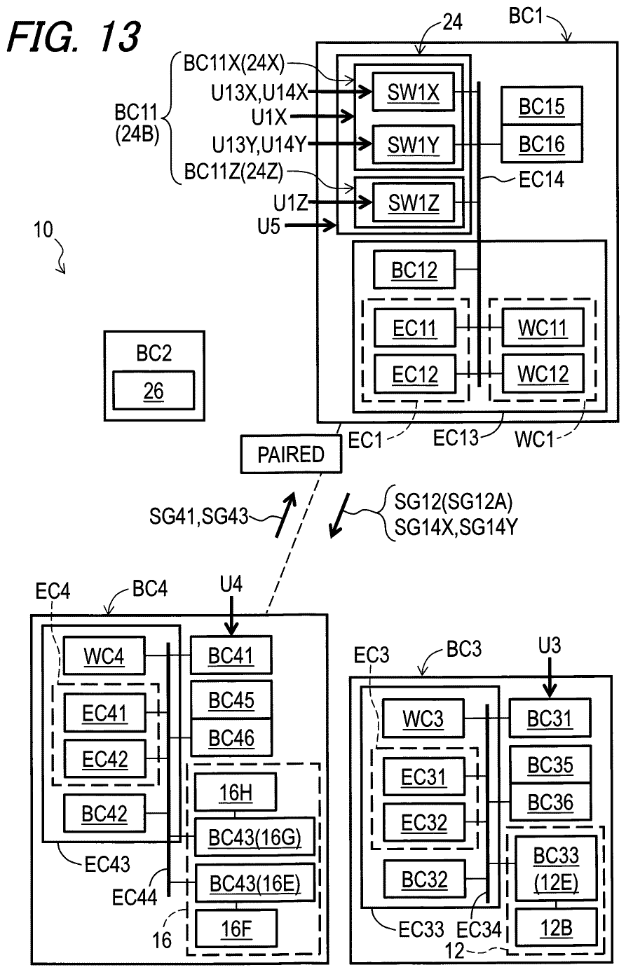

As seen in FIG. 13, the wireless communicator circuitry WC1 is configured to transmit a fourth wireless signal SG14X or SG14Y using the second communication protocol in response to the fourth user input U14X or U14Y in a second paired state where the human-powered vehicle component BC1 is paired with the second additional human-powered vehicle component BC4 using the first communication protocol. The controller circuitry EC1 is configured to control the wireless communicator circuitry WC1 to transmit the fourth wireless signal SG14X or SG14Y using the second communication protocol in response to the fourth user input U14X or U14Y in the second paired state. The wireless communicator circuitry WC1 can be configured to transmit a fourth wireless signal SG14X or SG14Y using a communication protocol different from the second communication protocol. In the second paired state, the human-powered vehicle component BC1 is paired with the second additional human-powered vehicle component BC4 using the first communication protocol while the human-powered vehicle component BC1 is not paired with the first additional human-powered vehicle component BC3.

Specifically, the second wireless communicator circuitry WC12 is configured to transmit the fourth wireless signal SG14X or SG14Y using the second communication protocol in response to the fourth user input U14X or U14Y in the second paired state. The controller circuitry EC1 is configured to control the second wireless communicator circuitry WC12 to transmit the fourth wireless signal SG14X or SG14Y using the second communication protocol in response to the fourth user input U14X or U14Y in the second paired state.

The fourth user input U14X or U14Y is different from the second user input U1Z. The fourth wireless signal SG14X or SG14Y is different from the second wireless signal SG12. The fourth wireless signal SG14X or SG14Y is free of indicating pairing between the human-powered vehicle component BC1 and another device. The fourth wireless signal SG14X or SG14Y is free of a pairing start signal.

For example, the fourth wireless signal SG14X or SG14Y can include the pairing information ID12 of the human-powered vehicle component BC1. The pairing information ID12 included in the fourth wireless signal SG14X or SG14Y includes the identification information and the second cryptographic key information.

The second additional wireless communicator circuitry WC4 is configured to receive the fourth wireless signal SG14X or SG14Y using the second communication protocol in the second paired state. The second additional controller circuitry EC4 is configured to control the second additional wireless communicator circuitry WC4 to receive the fourth wireless signal SG14X or SG14Y using the second communication protocol in the second paired state. The second additional controller circuitry EC4 is configured to store the second cryptographic key information of the pairing information ID12 included in the fourth wireless signal SG14X or SG14Y in the memory circuitry EC42. The second additional wireless communicator circuitry WC4 is configured to encrypt signals using the second cryptographic key information to generate encrypted wireless signals after the receipt of the fourth wireless signal SG14X or SG14Y.

The second additional controller circuitry EC4 is configured to control the second electric actuator BC43 based on the fourth wireless signal SG14X or SG14Y. In a case where the human-powered vehicle component BC1 is paired with the second additional human-powered vehicle component BC4 including the gear changer 12, the fourth wireless signal SG14X indicates upshifting of the gear changer 12, and the fourth wireless signal SG14Y indicates downshifting of the gear changer 12. Thus, the second additional controller circuitry EC4 is configured to control the second electric actuator BC43 to move the chain guide 12D in an upshifting direction based on the fourth wireless signal SG14X. The second additional controller circuitry EC4 is configured to control the second electric actuator BC43 to move the chain guide 12D in a downshifting direction based on the fourth wireless signal SG14Y.

In a case where the human-powered vehicle component BC1 is paired with the second additional human-powered vehicle component BC4 including the suspension 16, the fourth wireless signal SG14X indicates changing of the damping property of the suspension 16, and the fourth wireless signal SG14Y indicates changing of the stroke of the suspension 16. Thus, the second additional controller circuitry EC4 is configured to control the second electric actuator BC43 to actuate the state changing structure 16F to change the damping property of the suspension 16 based on the fourth wireless signal SG14X. The second additional controller circuitry EC4 is configured to control the second electric actuator BC43 to actuate the state changing structure 16H to change the stroke of the suspension 16 based on the fourth wireless signal SG14Y.

The second additional wireless communicator circuitry WC4 is configured to wirelessly transmit a second acknowledgement signal SG43 using the second communication protocol in response to the fourth wireless signal SG14X or SG14Y in the second paired state. The second additional controller circuitry EC4 is configured to control the second additional wireless communicator circuitry WC4 to wirelessly transmit the second acknowledgement signal SG43 using the second communication protocol in response to the fourth wireless signal SG14X or SG14Y in the second paired state.

For example, the second acknowledgement signal SG43 can include the second pairing information ID4 of the second additional human-powered vehicle component BC4. The second pairing information ID4 included in the second acknowledgement signal SG43 includes the second identification information and the second additional cryptographic key information.

The second wireless communicator circuitry WC12 is configured to scan the second acknowledgement signal SG43 using the second communication protocol after the transmission of the fourth wireless signal SG14X or SG14Y. The controller circuitry EC1 is configured to control the second wireless communicator circuitry WC12 to scan the second acknowledgement signal SG43 using the second communication protocol after the transmission of the fourth wireless signal SG14X or SG14Y. The controller circuitry EC1 is configured to recognize the second acknowledgement signal SG43 via the second wireless communicator circuitry WC12 using the second communication protocol. The controller circuitry EC1 is configured to store the second additional cryptographic key information of the second acknowledgement signal SG43 included in the second acknowledgement signal SG43 in the memory circuitry EC12. The second wireless communicator circuitry WC12 is configured to encrypt signals using the second additional cryptographic key information to generate encrypted wireless signals after the receipt of the second acknowledgement signal SG43.

As seen in FIG. 12, the wireless communicator circuitry WC1 is configured to restrict the first wireless signal SG11 from being transmitted using the first communication protocol in response to the first user input U1X in the first paired state where the human-powered vehicle component BC1 is paired with the first additional human-powered vehicle component BC3 using the first communication protocol. The first wireless communicator circuitry WC11 is configured to restrict the first wireless signal SG11 from being transmitted using the first communication protocol in response to the first user input U1X in the first paired state.

The wireless communicator circuitry WC1 is configured to restrict the second wireless signal SG12 from being transmitted using the second communication protocol in response to the second user input U1Z in the first paired state where the human-powered vehicle component BC1 is paired with the first additional human-powered vehicle component BC3 using the first communication protocol. The second wireless communicator circuitry WC12 is configured to restrict the second wireless signal SG12 from being transmitted using the second communication protocol in response to the second user input U1Z in the first paired state.

As seen in FIG. 13, the wireless communicator circuitry WC1 is configured to restrict the second wireless signal SG12 from being transmitted using the second communication protocol in response to the second user input U1Z in the second paired state where the human-powered vehicle component BC1 is paired with the second additional human-powered vehicle component BC4 using the second communication protocol. The second wireless communicator circuitry WC12 is configured to restrict the second wireless signal SG12 from being transmitted using the second communication protocol in response to the second user input U1Z in the second paired state.

The wireless communicator circuitry WC1 is configured to restrict the first wireless signal SG11 from being transmitted using the first communication protocol in response to the first user input U1X in the second paired state where the human-powered vehicle component BC1 is paired with the second additional human-powered vehicle component BC4 using the second communication protocol. The first wireless communicator circuitry WC11 is configured to restrict the first wireless signal SG11 from being transmitted using the first communication protocol in response to the first user input U1X in the second paired state.

As seen in FIG. 11, the wireless communicator circuitry WC1 is configured to reset the first paired state where the human-powered vehicle component BC1 is paired with the first additional human-powered vehicle component BC3. The wireless communicator circuitry WC1 is configured to reset, in response to the reset input U5, the first paired state where the human-powered vehicle component BC1 is paired with the first additional human-powered vehicle component BC3.

Specifically, the first wireless communicator circuitry WC11 is configured to reset the first paired state. The first wireless communicator circuitry WC11 is configured to reset the first paired state in response to the reset input U5.

The wireless communicator circuitry WC1 is configured to return, in response to the reset input U5, from the first paired state to the unpaired state where the human-powered vehicle component BC1 is not paired with the first additional human-powered vehicle component BC3. The first wireless communicator circuitry WC11 is configured to return from the first paired state to the unpaired state in response to the reset input U5. For example, the controller circuitry EC1 is configured to erase the first pairing information ID3 stored in the memory circuitry EC12.

The wireless communicator circuitry WC1 is configured to transmit the first wireless signal SG11 using the first communication protocol in response to the first user input U1X after resetting of the first paired state. The first wireless communicator circuitry WC11 is configured to transmit the first wireless signal SG11 using the first communication protocol in response to the first user input U1X after resetting of the first paired state.

The wireless communicator circuitry WC1 is configured to transmit the second wireless signal SG12 using the second communication protocol in response to the second user input U1Z after resetting of the first paired state. The second wireless communicator circuitry WC12 is configured to transmit the second wireless signal SG12 using the second communication protocol in response to the second user input U1Z after resetting of the first paired state.

As described above, the human-powered vehicle component BC1 is configured to be free of being paired with another human-powered vehicle component other than the first human-powered vehicle component BC3 in the first paired state without resetting of the first paired state. Thus, it is possible to prevent the human-powered vehicle component BC1 from being unintentionally paired with another human-powered vehicle component other than the first human-powered vehicle component BC3.

As seen in FIG. 11, the wireless communicator circuitry WC1 is configured to reset the second paired state where the human-powered vehicle component BC1 is paired with the second additional human-powered vehicle component BC4. The wireless communicator circuitry WC1 is configured to reset, in response to the reset input U5, the second paired state where the human-powered vehicle component BC1 is paired with the second additional human-powered vehicle component BC4.

Specifically, the second wireless communicator circuitry WC12 is configured to reset the second paired state. The wireless communicator circuitry WC1 is configured to reset the second paired state in response to the reset input U5.

The wireless communicator circuitry WC1 is configured to return, in response to the reset input U5, from the second paired state to the unpaired state where the human-powered vehicle component BC1 is not paired with the second additional human-powered vehicle component BC4. The second wireless communicator circuitry WC12 is configured to return from the second paired state to the unpaired state in response to the reset input U5. For example, the controller circuitry EC1 is configured to erase the second pairing information ID4 stored in the memory circuitry EC12.

The wireless communicator circuitry WC1 is configured to transmit the first wireless signal SG11 using the first communication protocol in response to the first user input U1X after resetting of the second paired state. The first wireless communicator circuitry WC11 is configured to transmit the first wireless signal SG11 using the first communication protocol in response to the first user input U1X after resetting of the second paired state.

The wireless communicator circuitry WC1 is configured to transmit the second wireless signal SG12 using the second communication protocol in response to the second user input U1Z after resetting of the second paired state. The second wireless communicator circuitry WC12 is configured to transmit the second wireless signal SG12 using the second communication protocol in response to the second user input U1Z after resetting of the second paired state.

As described above, the human-powered vehicle component BC1 is configured to be free of being paired with another human-powered vehicle component other than the second human-powered vehicle component BC4 in the second paired state without resetting of the second paired state. Thus, it is possible to prevent the human-powered vehicle component BC1 from being unintentionally paired with another human-powered vehicle component other than the second human-powered vehicle component BC4.

In the present embodiment, the wireless communicator circuitry WC1 is configured to reset, in response to the reset input U5 which is free of indicating an operation of another device, the first paired state where the human-powered vehicle component BC1 is paired with the first additional human-powered vehicle component BC3. The first wireless communicator circuitry WC11 is configured to reset the first paired state in response to the reset input U5 which is free of indicating an operation of another device. The wireless communicator circuitry WC1 is configured to reset, in response to the reset input U5 which is free of indicating an operation of another device, the second paired state where the human-powered vehicle component BC1 is paired with the second additional human-powered vehicle component BC4. The second wireless communicator circuitry WC12 is configured to reset the second paired state in response to the reset input U5 which is free of indicating an operation of another device.

Alternatively, the wireless communicator circuitry WC1 can be configured to reset, in response to the reset input U5 indicating an operation of another device, the first paired state where the human-powered vehicle component BC1 is paired with the first additional human-powered vehicle component BC3. The first wireless communicator circuitry WC11 can be configured to reset the first paired state in response to the reset input U5 indicating an operation of another device. The wireless communicator circuitry WC1 can be configured to reset, in response to the reset input U5 indicating an operation of another device, the second paired state where the human-powered vehicle component BC1 is paired with the second additional human-powered vehicle component BC4. The second wireless communicator circuitry WC12 can be configured to reset the second paired state in response to the reset input U5 indicating an operation of an additional device. Examples of the operation of the additional device include an operation of an external device ED (see e.g., FIG. 1), an operation of the first additional user interface circuitry BC31, and an operation of the second additional user interface circuitry BC41. Examples of the external device ED include a smartphone, a cycle computer, a tablet computer, and a wearable device.

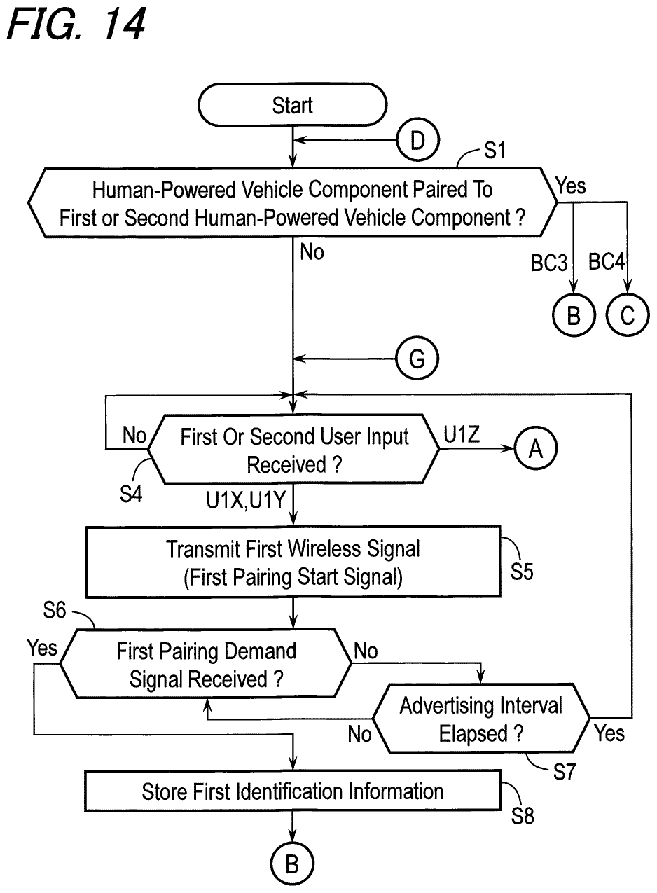

The wireless communication process executed between the human-powered vehicle component BC1 and each of the first additional human-powered vehicle component BC3 and the second additional human-powered vehicle component BC4 will be discussed below referring to FIGS. 14 to 21.

As seen in FIG. 14, the human-powered vehicle component BC1 starts when the trigger occurs. For example, the human-powered vehicle component BC1 starts when electric power is supplied to the human-powered vehicle component BC1.

In step S1, the controller circuitry EC1 first determines whether the human-powered vehicle component BC1 has already been paired to another human-powered vehicle component such as the first additional human-powered vehicle component BC3 or the second additional human-powered vehicle component BC4. For example, the controller circuitry EC1 reads the memory circuitry EC12 to determine whether pairing information such as the first pairing information ID3 or the second pairing information ID4 is stored in the memory circuitry EC12. Specifically, the controller circuitry EC1 reads the memory circuitry EC12 to determine the first identification information of the first pairing information ID3 or the second identification information of the second pairing information ID4 is stored in the memory circuitry EC12.

In a case where the controller circuitry EC1 concludes that the human-powered vehicle component BC1 has not been paired to the first additional human-powered vehicle component BC3 in step S1, the controller circuitry EC1 determines whether the user interface circuitry BC11 receives the first user input U1X or the second user input U1Z in step S4. For example, the first user input U1X includes the simultaneous long press of the first switches SW1X and SW1Y. The second user input U1Z includes the long press of the second switch SW1Z. In step S5, the controller circuitry EC1 controls the wireless communicator circuitry WC1 (e.g., the first wireless communicator circuitry WC11) to wirelessly transmit the first wireless signal SG11 using the first communication protocol in response to the first user input U1X. For example, the controller circuitry EC1 controls the wireless communicator circuitry WC1 (e.g., the first wireless communicator circuitry WC11) to wirelessly transmit the first pairing start signal SG11A using the first communication protocol in response to the first user input U1X.

The human-powered vehicle component BC1 can have a pairing mode. In such modifications, the human-powered vehicle component BC1 can be configured to enter the pairing mode after step S1 and to exit the pairing mode after step S8. Furthermore, after the start of the pairing mode, the controller circuitry EC1 may activate the notification device BC12 to produce a pairing notification indicating that the human-powered vehicle component BC1 enters the pairing mode. For example, the controller circuitry EC1 can be configured to control the LED of the notification device BC12 to flash in a specific cycle during the pairing mode. The controller circuitry EC1 can be configured to control the notification device BC12 to end the pairing notification.

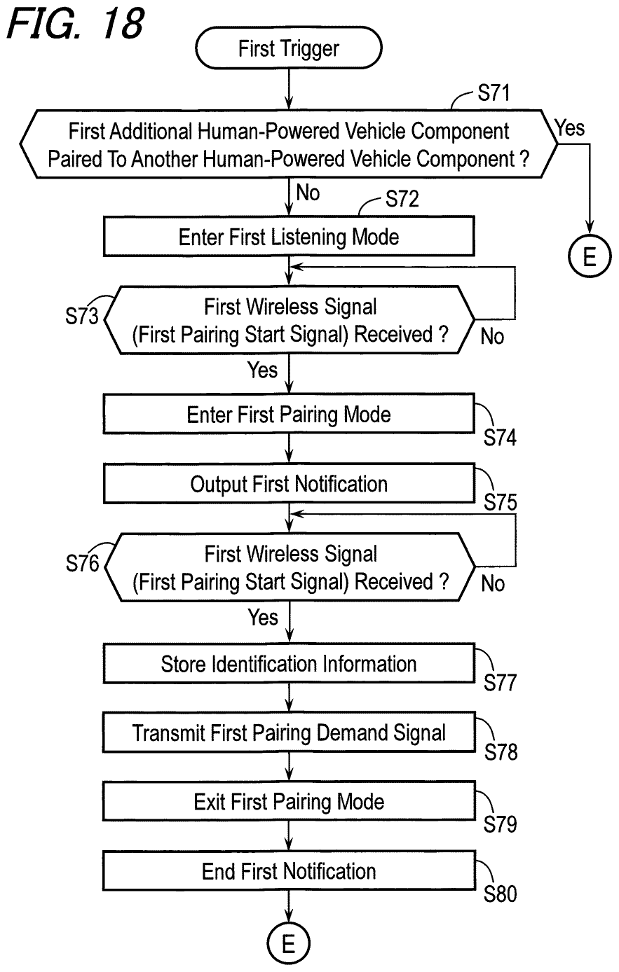

As seen in FIG. 18, the first additional human-powered vehicle component BC3 starts when the first trigger occurs. For example, the first additional human-powered vehicle component BC3 starts when electric power is supplied to the first additional human-powered vehicle component BC3. Alternatively, the first additional human-powered vehicle component BC3 can be configured to start based on another trigger such as the first additional user input U3 (e.g., a long press of the switch of the first additional user interface circuitry BC31).

In step S71, the first additional controller circuitry EC3 determines whether the first additional human-powered vehicle component BC3 has already been paired to another human-powered vehicle component such as the human-powered vehicle component BC1. For example, the first additional controller circuitry EC3 reads the memory circuitry EC32 to determine whether the pairing information ID11 of the human-powered vehicle component BC1 is stored in the memory circuitry EC32. Specifically, the first additional controller circuitry EC3 reads the memory circuitry EC32 to determine whether the identification information of the pairing information ID11 is stored in the memory circuitry EC32.

In a case where the first additional controller circuitry EC3 concludes that the first additional human-powered vehicle component BC3 has not been paired to the human-powered vehicle component BC1 in step S71, the first additional controller circuitry EC3 controls the first additional human-powered vehicle component BC3 to enter the first listening mode in step S72.

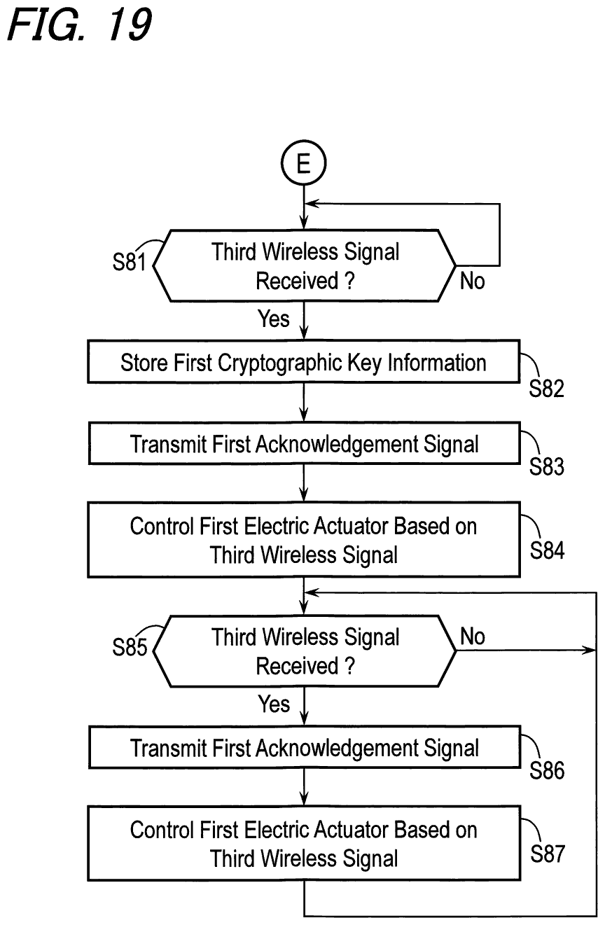

On the other hand, in a case where the first additional human-powered vehicle component BC3 has been paired to the human-powered vehicle component BC1, the first additional controller circuitry EC3 proceeds to steps of FIG. 19. Accordingly, the first additional controller circuitry EC3 is configured to prohibit the first additional human-powered vehicle component BC3 from entering the first listening mode and the first pairing mode in a state where pairing is established between the human-powered vehicle component BC1 and the first additional human-powered vehicle component BC3.

In step S73, the first additional controller circuitry EC3 controls the first additional wireless communicator circuitry WC3 to scan the first wireless signal SG11 (e.g., the first pairing start signal SG11A) using the first communication protocol in the first listening mode. In a case where the first additional controller circuitry EC3 detects the first wireless signal SG11 (e.g., the first pairing start signal SG11A) via the first additional wireless communicator circuitry WC3 in the first listening mode, the first additional controller circuitry EC3 causes the first additional human-powered vehicle component BC3 to enter the first pairing mode in response to the first wireless signal SG11 in step S74.

In step S75, the first additional controller circuitry EC3 activates the notification device BC32 to produce a first notification in response to entrance of the first additional human-powered vehicle component BC3 to the first pairing mode. For example, the first additional controller circuitry EC3 is configured to control the LED of the notification device BC32 to flash in a specific cycle during the first pairing mode. Next, the process proceeds to step S76. Steps S75 and S80 can be omitted from the flowchart.

In step S76, the first additional controller circuitry EC3 controls the first additional wireless communicator circuitry WC3 to scan the first wireless signal SG11 (e.g., the first pairing start signal SG11A) using the first communication protocol in the first listening mode. In a case where the first additional controller circuitry EC3 detects the first wireless signal SG11 (e.g., the first pairing start signal SG11A) via the first additional wireless communicator circuitry WC3 in the first listening mode, the first additional controller circuitry EC3 stores, in the memory circuitry EC32, the identification information of the pairing information ID11 included in the first wireless signal SG11 (e.g., the first pairing start signal SG11A) in step S77.

In step S78, the first additional controller circuitry EC3 controls the first additional wireless communicator circuitry WC3 to wirelessly transmit the first pairing demand signal SG31 using the first communication protocol in response to the first wireless signal SG11 (e.g., the first pairing start signal SG11A).

In step S79, the first additional controller circuitry EC3 exits the first pairing mode in response to the first wireless signal SG11 (e.g., the first pairing start signal SG11A) received in step S76. In step S80, the first additional controller circuitry EC3 controls the notification device BC32 to end the first notification after the receipt of the first wireless signal SG11 (e.g., the first pairing start signal SG11A). The process proceeds to steps of FIG. 19.

As seen in FIG. 14, in step S6, the controller circuitry EC1 controls the wireless communicator circuitry WC1 (e.g., the first wireless communicator circuitry WC11) to scan the first pairing demand signal SG31, which includes the pairing information ID11 (e.g., the identification information of the pairing information ID11), after the transmission of the first wireless signal SG11 (e.g., the first pairing start signal SG11A).

In step S7, the controller circuitry EC1 determines whether the advertising interval has elapsed from the transmission of the first wireless signal SG11 in a case where the human-powered vehicle component BC1 does not receive the first pairing demand signal SG31. In a case where the advertising interval has elapsed from the transmission of the first wireless signal SG1, the process returns to step S4. In a case where the advertising interval has not elapsed from the transmission of the first wireless signal SG1, the process returns to step S6, and then the controller circuitry EC1 controls the wireless communicator circuitry WC1 (e.g., the first wireless communicator circuitry WC11) to continue scanning the first pairing demand signal SG31. The process proceeds to step S8 in a case where the wireless communicator circuitry WC1 (e.g., the first wireless communicator circuitry WC11) wirelessly receives the first pairing demand signal SG31.

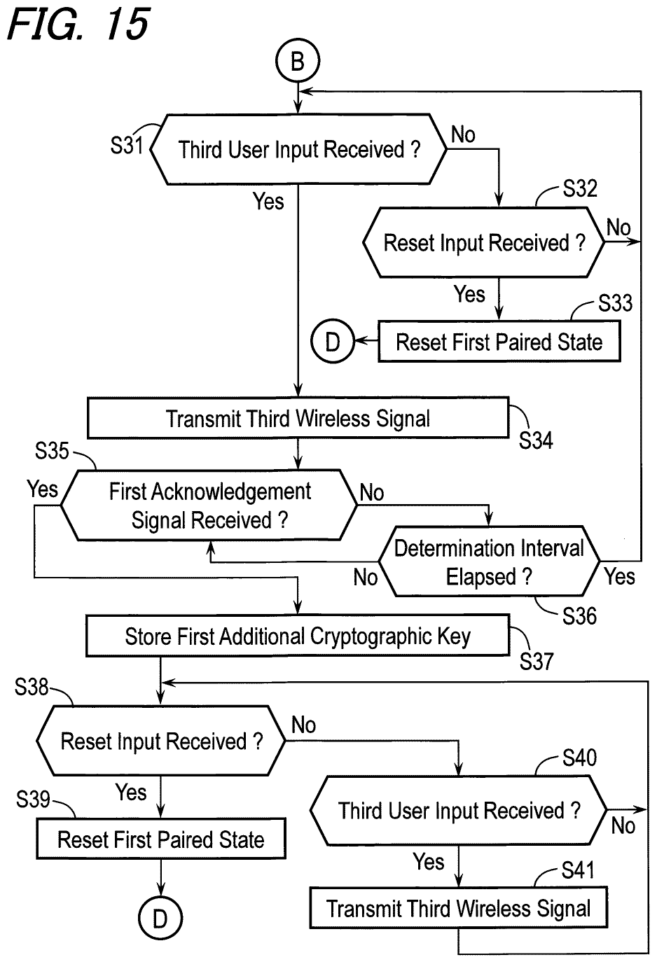

In step S8, the controller circuitry EC1 stores the first pairing information ID3 included in the first pairing demand signal SG31 in the memory circuitry EC12. For example, the controller circuitry EC1 stores the first identification information of the first pairing information ID3 included in the first pairing demand signal SG31 in the memory circuitry EC12. The controller circuitry EC1 does not store the first additional cryptographic key information at this stage even if the first pairing demand signal SG31 incudes the first additional cryptographic key information. The process proceeds to steps of FIG. 15.

As seen in FIG. 15, in step S31, the controller circuitry EC1 determines whether the user interface circuitry BC11 receives the third user input U13X or U13Y. For example, the third user input U13X includes the normal press of the first switch SW1X. The third user input U13Y includes the normal press of the first switch SW1Y. In a case where the user interface circuitry BC11 receives the third user input U13X in step S31, the controller circuitry EC1 controls the wireless communicator circuitry WC1 (e.g., the first wireless communicator circuitry WC11) to wirelessly transmit the third wireless signal SG13X in response to the third user input U13X in step S34. In a case where the user interface circuitry BC11 receives the third user input U13Y in step S31, the controller circuitry EC1 controls the wireless communicator circuitry WC1 (e.g., the first wireless communicator circuitry WC11) to wirelessly transmit the third wireless signal SG13Y in response to the third user input U13Y in step S34.

As seen in FIG. 19, in step S81, the first additional controller circuitry EC3 controls the first additional wireless communicator circuitry WC3 to scan the third wireless signal SG13X or SG13Y, which includes the pairing information ID11 (e.g., the first cryptographic key information), after the termination of the first pairing mode. In a case where the first additional controller circuitry EC3 recognizes the third wireless signal SG13X or SG13Y via the first additional wireless communicator circuitry WC3 in step S81, the first additional controller circuitry EC3 stores the first cryptographic key information of the pairing information ID11 in the memory circuitry EC32 in step S82.

In step S83, the first additional controller circuitry EC3 controls the first additional wireless communicator circuitry WC3 to wirelessly transmit the first acknowledgement signal SG33, which includes the first additional cryptographic key information of the first pairing information ID3.

In step S84, the first additional controller circuitry EC3 controls the first electric actuator BC33 based on the third wireless signal SG13X or SG13Y. In a case where the first additional human-powered vehicle component BC3 includes the gear changer 12, the first additional controller circuitry EC3 controls the first electric actuator BC33 to move the chain guide 12D in the upshifting or downshifting direction based on the third wireless signal SG13X or SG13Y. In a case where the first additional human-powered vehicle component BC3 includes the suspension 16, the first additional controller circuitry EC3 controls the first electric actuator BC33 to actuate the state changing structure 16F or 16H such that the damping property or the stroke is changed based on the third wireless signal SG13X or SG13Y.

As seen in FIG. 15, in step S35, the controller circuitry EC1 controls the wireless communicator circuitry WC1 (e.g., the first wireless communicator circuitry WC11) to scan the first acknowledgement signal SG33 from the first additional wireless communicator circuitry WC3, which includes the first pairing information ID3 (e.g., the first additional cryptographic key information), after the transmission of the third wireless signal SG13X or SG13Y.

In step S36, the controller circuitry EC1 determines whether the determination interval has elapsed from the transmission of the third wireless signal SG13X or SG13Y in a case where the human-powered vehicle component BC1 does not receive the first acknowledgement signal SG33. In a case where the determination interval has elapsed from the transmission of the third wireless signal SG13X or SG13Y, the process returns to step S31. In a case where the determination interval has not elapsed from the transmission of the third wireless signal SG13X or SG13Y, the process returns to step S35, and then the controller circuitry EC1 controls the first additional wireless communicator circuitry WC3 to continue scanning the first acknowledgement signal SG33. The process proceeds to step S37 in a case where the wireless communicator circuitry WC1 wirelessly receives the first acknowledgement signal SG33.

In step S37, the controller circuitry EC1 stores the first additional cryptographic key information of the first pairing information ID3 included in the first acknowledgement signal SG33 in the memory circuitry EC12. The process proceeds to step S38.

In step S32 or S38, the controller circuitry EC1 determines whether the user interface circuitry BC11 receives the reset input U5. For example, the reset input U5 includes the simultaneous press of the first switch SW1X, the first switch SW1Y, and the second switch SW1Z. In a case where the user interface circuitry BC11 receives the reset input U5, the controller circuitry EC1 resets pairing in step S33 or S39. For example, the controller circuitry EC1 erases the first pairing information ID3 stored in the memory circuitry EC12 in step S33 or S39. The process proceeds to step S1 of FIG. 14. In a case where the user interface circuitry BC11 does not receive the reset input U5, the process proceeds to step S40.

In step S40, the controller circuitry EC1 determines whether the user interface circuitry BC11 receives the third user input U13X or U13Y. In a case where the user interface circuitry BC11 receives neither the third user input U13X nor U13Y, the process returns to step S38.

In a case where the user interface circuitry BC11 receives the third user input U13X in step S40, the controller circuitry EC1 controls the wireless communicator circuitry WC1 (e.g., the first wireless communicator circuitry WC11) to wirelessly transmit the third wireless signal SG13X in response to the third user input U13X in step S41. In a case where the user interface circuitry BC11 receives the third user input U13Y in step S40, the controller circuitry EC1 controls the wireless communicator circuitry WC1 (e.g., the first wireless communicator circuitry WC11) to wirelessly transmit the third wireless signal SG13Y in response to the third user input U13Y in step S41.

As seen in FIGS. 12 and 14, in a case where the user interface circuitry 24B receives the second user input U1Z in step S4, the controller circuitry EC1 controls the wireless communicator circuitry WC1 (e.g., the second wireless communicator circuitry WC12) to wirelessly transmit the second wireless signal SG12 using the second communication protocol in response to the second user input U1Z in step S15. For example, the controller circuitry EC1 controls the wireless communicator circuitry WC1 (e.g., the second wireless communicator circuitry WC12) to wirelessly transmit the second pairing start signal SG12A using the second communication protocol in response to the second user input U1Z.

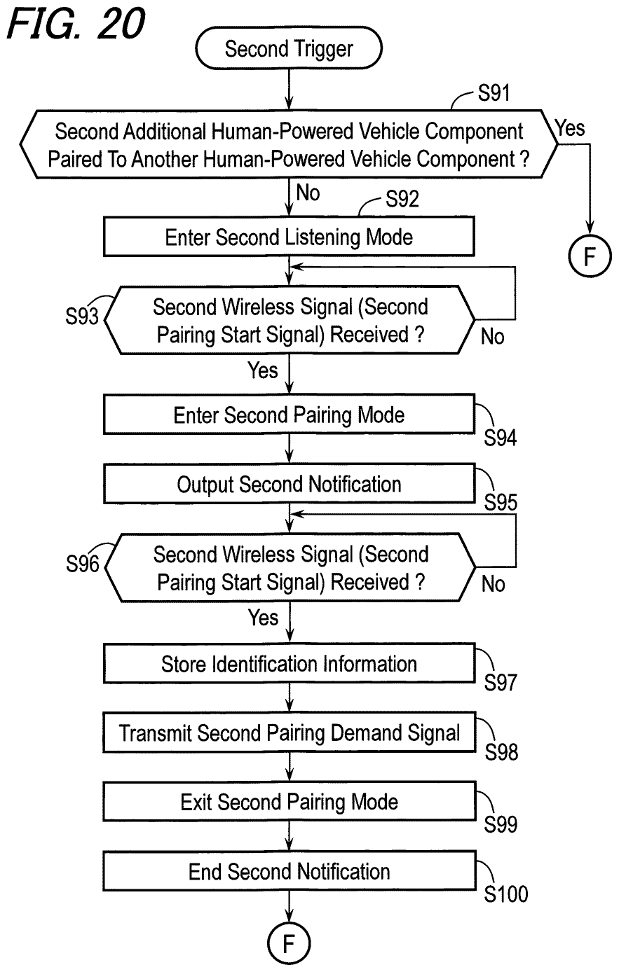

As seen in FIG. 20, the second additional human-powered vehicle component BC4 starts when the second trigger occurs. For example, the second additional human-powered vehicle component BC4 starts when electric power is supplied to the second additional human-powered vehicle component BC4. Alternatively, the second additional human-powered vehicle component BC4 can be configured to start based on another trigger such as the second additional user input U4 (e.g., a long press of the switch of the second additional user interface circuitry BC41).

In step S91, the second additional controller circuitry EC4 determines whether the second additional human-powered vehicle component BC4 has already been paired to another human-powered vehicle component such as the human-powered vehicle component BC1. For example, the second additional controller circuitry EC4 reads the memory circuitry EC42 to determine whether the pairing information ID12 of the human-powered vehicle component BC1 is stored in the memory circuitry EC42. Specifically, the second additional controller circuitry EC4 reads the memory circuitry EC42 to determine whether the identification information of the pairing information ID12 is stored in the memory circuitry EC42.

In a case where the second additional controller circuitry EC4 concludes that the second additional human-powered vehicle component BC4 has not been paired to the human-powered vehicle component BC1 in step S91, the second additional controller circuitry EC4 controls the second additional human-powered vehicle component BC4 to enter the second listening mode in step S92.

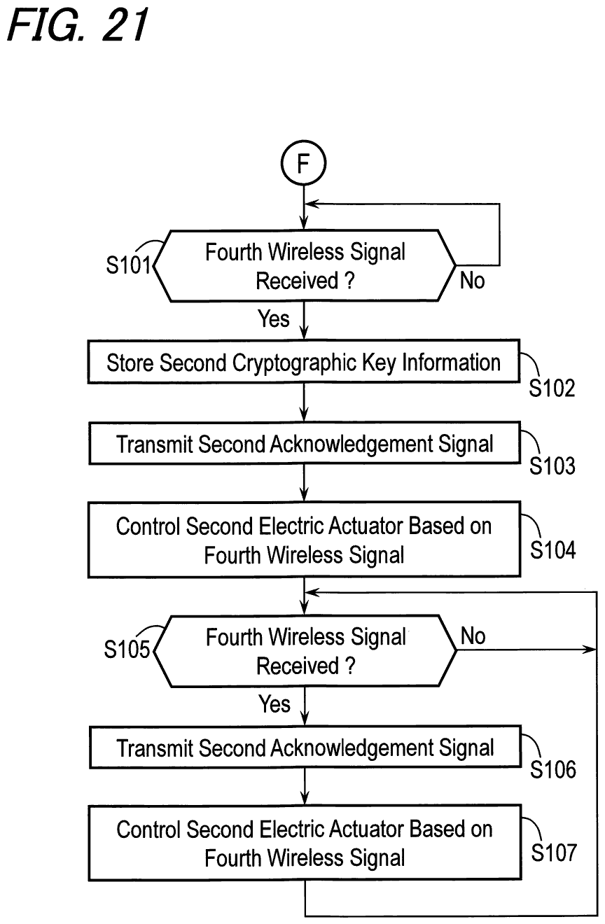

On the other hand, in a case where the second additional human-powered vehicle component BC4 has been paired to the human-powered vehicle component BC1, then the second additional controller circuitry EC4 proceeds to steps of FIG. 21. Accordingly, the second additional controller circuitry EC4 is configured to prohibit the second additional human-powered vehicle component BC4 from entering the second listening mode and the second pairing mode in a state where pairing is established between the human-powered vehicle component BC1 and the second additional human-powered vehicle component BC4.

In step S93, the second additional controller circuitry EC4 controls the second additional wireless communicator circuitry WC4 to scan the second wireless signal SG12 (e.g., the second pairing start signal SG12A) using the second communication protocol in the second listening mode. In a case where the second additional controller circuitry EC4 detects the second wireless signal SG12 (e.g., the second pairing start signal SG12A) via the second additional wireless communicator circuitry WC4 in the second listening mode, the second additional controller circuitry EC4 causes the second additional human-powered vehicle component BC4 to enter the second pairing mode in response to the second wireless signal SG12 in step S94.

In step S95, the second additional controller circuitry EC4 activates the notification device BC42 to produce a second notification in response to entrance of the second additional human-powered vehicle component BC4 to the second pairing mode. For example, the second additional controller circuitry EC4 is configured to control the LED of the notification device BC42 to flash in a specific cycle during the second pairing mode.

Next, the process proceeds to step S96. Steps S95 and S100 can be omitted from the flowchart.

In step S96, the second additional controller circuitry EC4 controls the second additional wireless communicator circuitry WC4 to scan the second wireless signal SG12 (e.g., the second pairing start signal SG12A) using the second communication protocol in the second listening mode. In a case where the second additional controller circuitry EC4 detects the second wireless signal SG12 (e.g., the second pairing start signal SG12A) via the second additional wireless communicator circuitry WC4 in the second listening mode, the second additional controller circuitry EC4 stores, in the memory circuitry EC42, the identification information of the pairing information ID12 included in the second wireless signal SG12 (e.g., the second pairing start signal SG12A) in step S97.

In step S98, the second additional controller circuitry EC4 controls the second additional wireless communicator circuitry WC4 to wirelessly transmit the second pairing demand signal SG41 using the second communication protocol in response to the second wireless signal SG12 (e.g., the second pairing start signal SG12A).

In step S99, the second additional controller circuitry EC4 exits the second pairing mode in response to the second wireless signal SG12 (e.g., the second pairing start signal SG12A) received in step S96. In step S100, the second additional controller circuitry EC4 controls the notification device BC32 to end the second notification after the receipt of the second wireless signal SG12 (e.g., the second pairing start signal SG12A). The process proceeds to steps of FIG. 21.

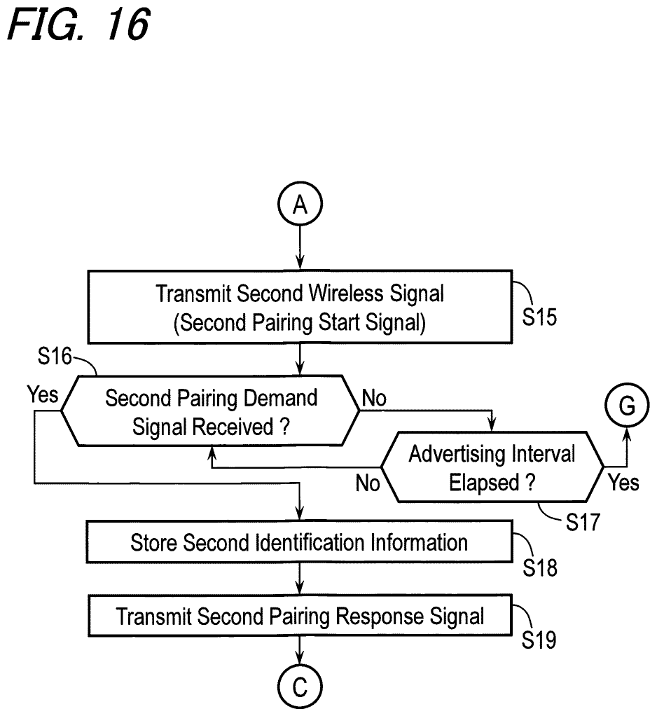

As seen in FIG. 16, in step S16, the controller circuitry EC1 controls the wireless communicator circuitry WC1 (e.g., the second wireless communicator circuitry WC12) to scan the second pairing demand signal SG41, which includes the pairing information ID12 (e.g., the identification information of the pairing information ID12), after the transmission of the second wireless signal SG12 (e.g., the second pairing start signal SG12A).

In step S17, the controller circuitry EC1 determines whether the advertising interval has elapsed from the transmission of the second wireless signal SG12 in a case where the human-powered vehicle component BC1 does not receive the second pairing demand signal SG41. In a case where the advertising interval has elapsed from the transmission of the second wireless signal SG12, the process returns to step S4 of FIG. 14. In a case where the advertising interval has not elapsed from the transmission of the second wireless signal SG12, the process returns to step S16, and then the controller circuitry EC1 controls the wireless communicator circuitry WC1 (e.g., the second wireless communicator circuitry WC12) to continue scanning the second pairing demand signal SG41. The process proceeds to step S18 in a case where the wireless communicator circuitry WC1 (e.g., the second wireless communicator circuitry WC12) wirelessly receives the second pairing demand signal SG41.

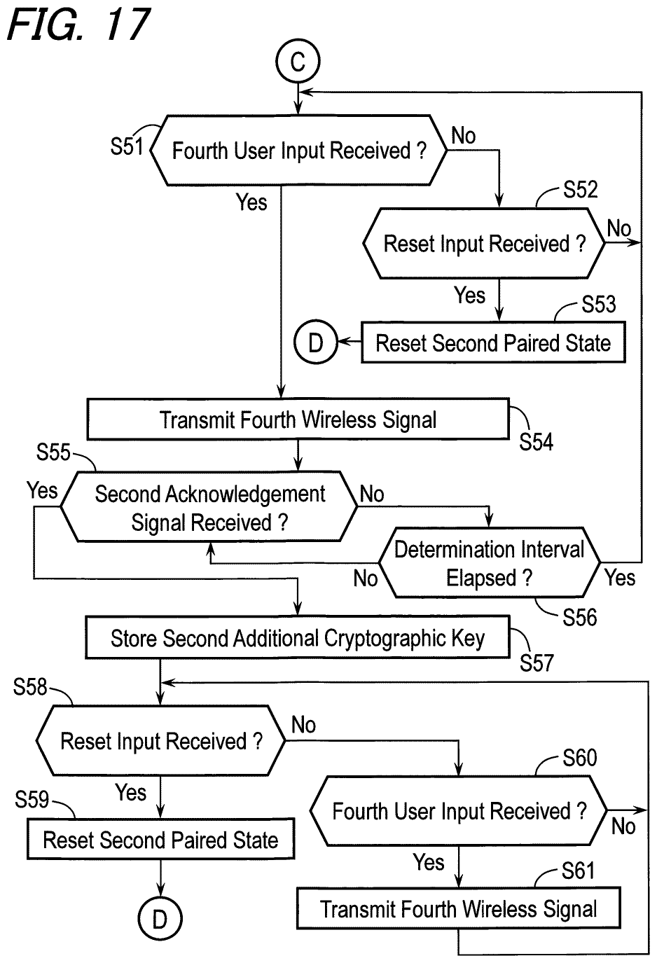

In step S18, the controller circuitry EC1 stores the second pairing information ID4 included in the second pairing demand signal SG41 in the memory circuitry EC12. For example, the controller circuitry EC1 stores the second identification information of the second pairing information ID4 included in the second pairing demand signal SG41 in the memory circuitry EC12. The controller circuitry EC1 does not store the second additional cryptographic key information at this stage even if the second pairing demand signal SG41 incudes the second additional cryptographic key information. The process proceeds to steps of FIG. 17.

As seen in FIG. 17, in step S51, the controller circuitry EC1 determines whether the user interface circuitry BC11 receives the fourth user input U14X or U14Y. For example, the fourth user input U14X includes the normal press of the first switch SW1X. The fourth user input U14Y includes the normal press of the first switch SW1Y. In a case where the user interface circuitry BC11 receives the fourth user input U14X in step S51, the controller circuitry EC1 controls the wireless communicator circuitry WC1 (e.g., the second wireless communicator circuitry WC12) to wirelessly transmit the fourth wireless signal SG14X in response to the fourth user input U14X in step S54. In a case where the user interface circuitry BC11 receives the fourth user input U14Y in step S51, the controller circuitry EC1 controls the wireless communicator circuitry WC1 (e.g., the second wireless communicator circuitry WC12) to wirelessly transmit the fourth wireless signal SG14Y in response to the fourth user input U14Y in step S54.

As seen in FIG. 21, in step S101, the second additional controller circuitry EC4 controls the second additional wireless communicator circuitry WC4 to scan the fourth wireless signal SG14X or SG14Y, which includes the pairing information ID12 (e.g., the second cryptographic key information), after the termination of the second pairing mode. In a case where the second additional controller circuitry EC4 recognizes the fourth wireless signal SG14X or SG14Y via the second additional wireless communicator circuitry WC4 in step S101, the second additional controller circuitry EC4 stores the second cryptographic key information of the pairing information ID12 in the memory circuitry EC42 in step S102.

In step S103, the second additional controller circuitry EC4 controls the second additional wireless communicator circuitry WC4 to wirelessly transmit the second acknowledgement signal SG43, which includes the second additional cryptographic key information of the second pairing information ID4.

In step S104, the second additional controller circuitry EC4 controls the second electric actuator BC43 based on the fourth wireless signal SG14X or SG14Y. In a case where the second additional human-powered vehicle component BC4 includes the gear changer 12, the second additional controller circuitry EC4 controls the second electric actuator BC43 to move the chain guide 12D in the upshifting or downshifting direction based on the fourth wireless signal SG14X or SG14Y. In a case where the second additional human-powered vehicle component BC4 includes the suspension 16, the second additional controller circuitry EC4 controls the second electric actuator BC43 to actuate the state changing structure 16F or 16H such that the damping property or the stroke is changed based on the fourth wireless signal SG14X or SG14Y.

As seen in FIG. 17, in step S55, the controller circuitry EC1 controls the wireless communicator circuitry WC1 (e.g., the second wireless communicator circuitry WC12) to scan the second acknowledgement signal SG43 from the second additional wireless communicator circuitry WC4, which includes the second pairing information ID4 (e.g., the second additional cryptographic key information), after the transmission of the fourth wireless signal SG14X or SG14Y.

In step S56, the controller circuitry EC1 determines whether the determination interval has elapsed from the transmission of the fourth wireless signal SG14X or SG14Y in a case where the human-powered vehicle component BC1 does not receive the second acknowledgement signal SG43. In a case where the determination interval has elapsed from the transmission of the fourth wireless signal SG14X or SG14Y, the process returns to step S51. In a case where the determination interval has not elapsed from the transmission of the fourth wireless signal SG14X or SG14Y, the process returns to step S55, and then the controller circuitry EC1 controls the second additional wireless communicator circuitry WC4 to continue scanning the second acknowledgement signal SG43. The process proceeds to step S57 in a case where the wireless communicator circuitry WC1 wirelessly receives the second acknowledgement signal SG43.

In step S57, the controller circuitry EC1 stores the second additional cryptographic key information of the second pairing information ID4 included in the second acknowledgement signal SG43 in the memory circuitry EC12. The process proceeds to step S58.

In step S52 or S58, the controller circuitry EC1 determines whether the user interface circuitry BC11 receives the reset input U5. For example, the reset input U5 includes the simultaneous press of the first switch SW1X, the first switch SW1Y, and the second switch SW1Z. In a case where the user interface circuitry BC11 receives the reset input U5, the controller circuitry EC1 resets pairing in step S53 or S59. For example, the controller circuitry EC1 erases the second pairing information ID4 stored in the memory circuitry EC12 in step S53 or S59. The process proceeds to step S1 of FIG. 14. In a case where the user interface circuitry BC11 does not receive the reset input U5, the process proceeds to step S60.

In step S60, the controller circuitry EC1 determines whether the user interface circuitry BC11 receives the fourth user input U14X or U14Y. In a case where the user interface circuitry BC11 receives neither the fourth user input U14X nor U14Y, the process returns to step S58.

In a case where the user interface circuitry BC11 receives the fourth user input U14X in step S60, the controller circuitry EC1 controls the wireless communicator circuitry WC1 (e.g., the second wireless communicator circuitry WC12) to wirelessly transmit the fourth wireless signal SG14X in response to the fourth user input U14X in step S61. In a case where the user interface circuitry BC11 receives the fourth user input U14Y in step S60, the controller circuitry EC1 controls the wireless communicator circuitry WC1 (e.g., the second wireless communicator circuitry WC12) to wirelessly transmit the fourth wireless signal SG14Y in response to the fourth user input U14Y in step S61.

The human-powered vehicle component BC2 including the operating device 26 can be paired to the second additional human-powered vehicle component BC4 including the suspension 16 based on the wireless communication process depicted in FIGS. 14 to 21. For example, the human-powered vehicle component BC2 including the operating device 26 can be paired to the second additional human-powered vehicle component BC4 including the suspension 16 using the second communication protocol while the human-powered vehicle component BC1 including the operating device 24 can be paired to the first additional human-powered vehicle component BC3 including the gear changer 12 using the first communication protocol.

The controller circuitry EC1 can be configured to enter a pairing mode which uses the first communication protocol in response to the first user input U1X including the simultaneous long press of the first switches SW1X and SW1Y. The controller circuitry EC1 can be configured to enter the pairing mode which uses the first communication protocol in response to another input such as the simultaneous press of the first switch SW1X, the first switch SW1Y, and the second switch SW1Z.

The controller circuitry EC1 can be configured to enter the pairing mode which uses the first communication protocol in response to the second user input U1Z including the long press of the second switch SW1Z. The controller circuitry EC1 can be configured to enter the pairing mode which uses the second communication protocol in response to another input such as the simultaneous press of the first switch SW1X, the first switch SW1Y, and the second switch SW1Z.

In the present embodiment and the modifications thereof, the controller circuitry EC1 is configured to reset each of the first paired state and the second paired state in response to the reset input U5. Alternatively, the controller circuitry EC1 can be configured to reset the first paired state in a first reset input while the controller circuitry EC1 can be configured to reset the second paired state in response to a second reset input different from the first reset input. Furthermore, the controller circuitry EC1 can be configured to reset the first paired state or the second paired state in response to the reset input U5 including an input other than the simultaneous press of the first switch SW1X, the first switch SW1Y, and the second switch SW1Z.

As seen in FIG. 6, in a case where the first additional human-powered vehicle component BC3 or the second additional human-powered vehicle component BC4 includes the assist drive unit 22, the human-powered vehicle component BC1 can be configured to be connected wirelessly to the assist operating device 22F. In such modifications, the first additional wireless communicator circuitry WC3 or the second additional wireless communicator circuitry WC4 is provided to the assist operating device 22F. The human-powered vehicle component BC1 can be configured to communicate with the first additional controller circuitry EC3 or the second additional controller circuitry EC4 via the first additional wireless communicator circuitry WC3 or the second additional wireless communicator circuitry WC4 of the assist operating device 22F. Furthermore, the first additional user interface circuitry BC31 or the second additional user interface circuitry BC41 is provided to the assist operating device 22F. Namely, the assist operating device 22F is configured to receive the first additional user input U3 or the second additional user input U4. For example, the first additional human-powered vehicle component BC3 including the assist drive unit 22 enters the first pairing mode in response to the first additional user input U3 (e.g., the press of the switch of the first additional user interface circuitry BC31). The second additional human-powered vehicle component BC4 including the assist drive unit 22 enters the second pairing mode in response to the second additional user input U4 (e.g., the press of the switch of the second additional user interface circuitry BC41).

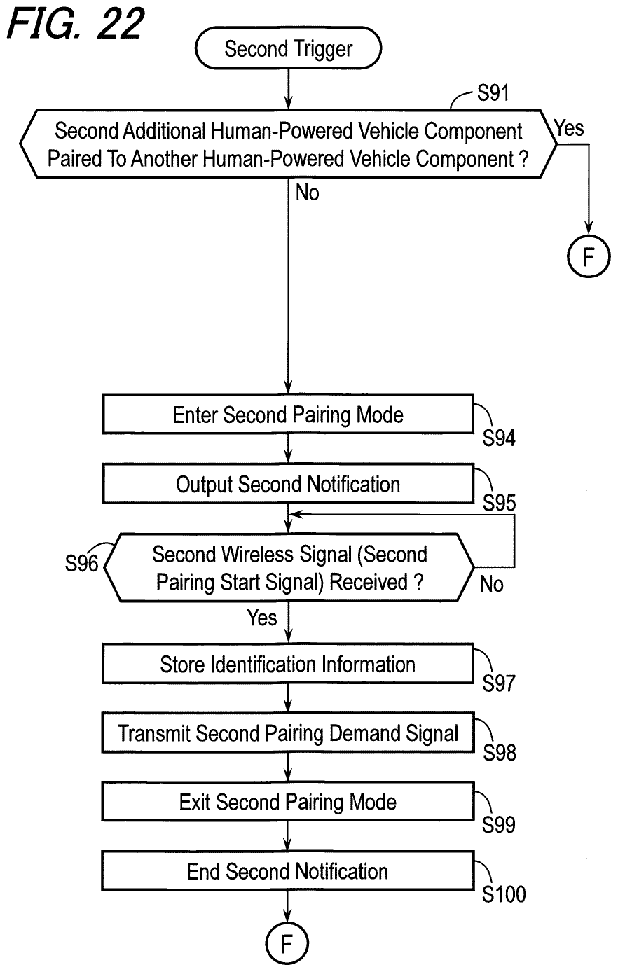

In the present embodiment and the modifications thereof, the second additional human-powered vehicle component BC4 is configured to enter the second pairing mode in response to the second wireless signal SG12. As seen in FIG. 22, however, the second additional human-powered vehicle component BC4 can be configured to enter the second pairing mode in response to pressing a button of the second additional human-powered vehicle component BC4. In FIG. 22, steps S92 and S93 are omitted from the flowchart illustrated in FIG. 20. The second trigger includes the second additional user input U4 having the pressing of the button of the second additional user interface circuitry BC41. The second additional human-powered vehicle component BC4 can be configured to enter the second pairing mode in response to the long press of the button of the second additional user interface circuitry BC41. The same can apply to the first additional human-powered vehicle component BC3.

In the present embodiment and the modifications thereof, the first additional human-powered vehicle component BC3 enters the first pairing mode in response to the first wireless signal SG11. Alternatively, the first additional human-powered vehicle component BC3 can be configured to enter the first pairing mode in response to another trigger such as a signal transmitted from the external device ED (see e.g., FIG. 1). The same can apply to the second additional human-powered vehicle component BC4.

In the present embodiment and the modifications thereof, the first user input U1X is the simultaneous long press of the first switches SW1X and SW1Y. The second user input U1Z is the long press of the second switch SW1Z. Alternatively, the first user input U1X and the second user input U1Z can use the same switch(s) in different manners. For example, the first user input U1X can be the long press of the second switch SW1Z while the second user input U1Z can be the normal press of the second switch SW1Z. The first user input U1X can be a first long press of the second switch SW1Z while the second user input U1Z can be a second press of the second switch SW1Z. The first long press has a first press time different from a second press time of the second long press. Furthermore, the first user input U1X can have a first action (e.g., pressing) applied to the second switch SW1Z while the second user input U1Z can have a second action (e.g., releasing) applied to the second switch SW1Z.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. A human-powered vehicle component comprising:
wireless communicator circuitry configured to transmit a first wireless signal to a first additional human-powered vehicle component using a first communication protocol in response to a first user input, the wireless communicator circuitry being configured to transmit a second wireless signal to a second additional human-powered vehicle component using a second communication protocol different from the first communication protocol in response to a second user input different from the first user input.

2. The human-powered vehicle component according to claim 1, wherein
the wireless communicator circuitry is configured to be free of transmitting the first wireless signal using the first communication protocol in response to the second user input, and
the wireless communicator circuitry is configured to be free of transmitting the second wireless signal using the second communication protocol in response to the first user input.

3. The human-powered vehicle component according to claim 1, further comprising:
first user interface circuitry configured to receive the first user input; and
second user interface circuitry configured to receive the second user input.

4. The human-powered vehicle component according to claim 1, further comprising:
memory circuitry configured to store assignment information, wherein
the assignment information includes first assignment information indicating that the first user input is assigned to the first communication protocol, and
the assignment information includes second assignment information indicating that the second user input is assigned to the second communication protocol.

5. The human-powered vehicle component according to claim 1, wherein
the first wireless signal includes a first pairing start signal,
the second wireless signal includes a second pairing start signal,
the wireless communicator circuitry is configured to wirelessly transmit the first pairing start signal to the first additional human-powered vehicle component using the first communication protocol in response to the first user input, and
the wireless communicator circuitry is configured to wirelessly transmit the second pairing start signal to the second additional human-powered vehicle component using the second communication protocol in response to the second user input.

6. The human-powered vehicle component according to claim 5, wherein
the wireless communicator circuitry is configured to transmit a third wireless signal using the first communication protocol in response to a third user input in a first paired state where the human-powered vehicle component is paired with the first additional human-powered vehicle component using the first communication protocol,
the third user input is different from the first user input, and
the third wireless signal is free of indicating pairing between the human-powered vehicle component and another device.

7. The human-powered vehicle component according to claim 5, wherein
the wireless communicator circuitry is configured to transmit a fourth wireless signal using the second communication protocol in response to a fourth user input in a second paired state where the human-powered vehicle component is paired with the second additional human-powered vehicle component using the first communication protocol,
the fourth user input is different from the second user input, and
the fourth wireless signal is free of indicating pairing between the human-powered vehicle component and another device.

8. The human-powered vehicle component according to claim 5, wherein
the first pairing start signal indicates that the first additional human-powered vehicle component enters a first pairing mode.

9. The human-powered vehicle component according to claim 5, wherein
the second additional human-powered vehicle component is configured to enter a second pairing mode in response to pressing a button of the second additional human-powered vehicle component.

10. The human-powered vehicle component according to claim 5, wherein
the wireless communicator circuitry is configured to receive a first pairing demand signal transmitted wirelessly from the first additional human-powered vehicle component using the first communication protocol in response to the first pairing start signal, and
the wireless communicator circuitry is configured to receive a second pairing demand signal transmitted wirelessly from the second additional human-powered vehicle component using the second communication protocol in response to the second pairing start signal.

11. The human-powered vehicle component according to claim 1, wherein
the wireless communicator circuitry is configured to restrict the second wireless signal from being transmitted using the second communication protocol in response to the second user input in a first paired state where the human-powered vehicle component is paired with the first additional human-powered vehicle component using the first communication protocol.

12. The human-powered vehicle component according to claim 1, wherein
the wireless communicator circuitry is configured to restrict the first wireless signal from being transmitted using the first communication protocol in response to the first user input in a first paired state where the human-powered vehicle component is paired with the first additional human-powered vehicle component using the first communication protocol.

13. The human-powered vehicle component according to claim 1, wherein
the wireless communicator circuitry is configured to restrict the second wireless signal from being transmitted using the second communication protocol in response to the second user input in a second paired state where the human-powered vehicle component is paired with the second additional human-powered vehicle component using the second communication protocol.

14. The human-powered vehicle component according to claim 1, wherein
the wireless communicator circuitry is configured to restrict the first wireless signal from being transmitted using the first communication protocol in response to the first user input in a second paired state where the human-powered vehicle component is paired with the second additional human-powered vehicle component using the second communication protocol.

15. The human-powered vehicle component according to claim 1, wherein
the wireless communicator circuitry is configured to reset a first paired state where the human-powered vehicle component is paired with the first additional human-powered vehicle component,
the wireless communicator circuitry is configured to transmit the first wireless signal using the first communication protocol in response to the first user input after resetting of the first paired state, and
the wireless communicator circuitry is configured to transmit the second wireless signal using the second communication protocol in response to the second user input after resetting of the first paired state.

16. The human-powered vehicle component according to claim 1, wherein
the wireless communicator circuitry is configured to reset, in response to a reset input, a first paired state where the human-powered vehicle component is paired with the first additional human-powered vehicle component, and
the wireless communicator circuitry is configured to reset, in response to the reset input, a second paired state where the human-powered vehicle component is paired with the second additional human-powered vehicle component.

17. The human-powered vehicle component according to claim 1, further comprising:
user interface circuitry configured to receive a reset input, wherein
the wireless communicator circuitry is configured to reset, in response to the reset input, a first paired state where the human-powered vehicle component is paired with the first additional human-powered vehicle component.

18. The human-powered vehicle component according to claim 1, wherein
the wireless communicator circuitry is configured to reset, in response to a reset input indicating an operation of another device, a first paired state where the human-powered vehicle component is paired with the first additional human-powered vehicle component.

19. The human-powered vehicle component according to claim 1, wherein
the first additional human-powered vehicle component includes a first electric actuator, and
the second additional human-powered vehicle component includes a second electric actuator.

20. The human-powered vehicle component according to claim 19, wherein
the first additional human-powered vehicle component is configured to be disposed in a first position, and
the second additional human-powered vehicle component is configured to be disposed in a second position which is remote from the first position.
